(19) United States
(12) Patent Application Publication
(10) Pub. No.: US 2009/0120306 A1
(43) Pub. Date: May 14, 2009

(54) Systems and methods of mixing and cooling food products

(76) Inventors: John M. DeCarlo, York, ME (US); Madison H. Finlay, Worcester, MA (US); Steven P. Moysey, South Grafton, MA (US); Sean A. Penderqast, Berlin, MA (US); Paul R. Kateman, Wellesley, MA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/229,524

(22) Filed: Aug. 22, 2008

Related U.S. Application Data
(60) Provisional application No. 60/966,075, filed on Aug. 23, 2007.
(60) Provisional application No. 60/958,000, filed on Aug. 24, 2007.

(51) Int. Cl. A47J 43/04; F25D 11/00; F25C 1/00

(52) U.S. Cl. 99/485; 62/441; 62/340

(57) ABSTRACT

A food-zone system for preparing a food product, such as a chilled or at least partially frozen food product, includes at least one chamber assembly including a chamber with an interior configuration that defines a food passage extending therethrough with a cylindrical or tubular shape. The chamber is sealed along at least one end and includes an exterior wall configured as a refrigerated wall that includes an interior adapted to circulate coolant. A scraping tool operatively couples with the chamber and extends into the food passage. The scraping tool is configured such that an outer perimeter of the scraping tool contacts at least a portion of the interior configuration of the chamber. As the scraping tool moves through the food passage, the scraping tool removes or scrapes a food product mix disposed, preferably as a thin layer or coating, along at least a portion of the interior configuration of the chamber when the food product is chilled or at least partially frozen. The scraping tool may be replaced with any of a variety of tools to perform different tasks of a food production cycle, including, but not limiting to, an applicator and coating tools for application or coating of a product mix, product mix ingredients, cleaning and/or other materials along the interior configuration of the chamber or inner wall of the food passage. The chamber may also serve as a mixing chamber. The food-zone system may be further arranged with multiple chambers serving as mixing and/or chilling/freezing chambers.

### RELATED APPLICATIONS

This application claims priority to U.S. provisional patent application Ser. No. 60/966,075, filed Aug. 23, 2007, and U.S. provisional patent application Ser. No. 60/958,000, filed Aug. 24, 2007, the contents of which are hereby incorporated by reference in their entireties.

### TECHNICAL FIELD

The present invention relates to systems and methods for producing and dispensing products, such as food products. More particularly, it relates to apparatuses and methods for the efficient aeration and/or blending, mixing, cooling, freezing, and formation of on-demand servings of food products.

### BACKGROUND

U.S. Patent Application Publication No. 2006/0054614 A1 (J. Baxter, et al., “Systems and Methods for Dispensing Product,” filed May 27, 2005) is fully incorporated into this disclosure. This earlier-filed patent application discloses systems and methods for producing and dispensing aerated and/or blended products, such as food products, using thin film cooling or freezing.

Described in the pages that follow are various improvements and alternative embodiments for components and sub-processes that can be substituted into the apparatus and methods described in US 2006/0054614 A1, as well as into other apparatus for producing aerated and/or non-aerated blended food products, such as frozen or partially frozen food products and cooled or chilled food products. The systems and methods of the present invention can substitute the food-preparation assembly 22 described with reference to the apparatus of US 2006/0054614 A1. In addition, the systems and methods of the present invention can be incorporated with one or more systems and/or subassemblies of such systems described in U.S. Pat. Nos. 6,952,928, 6,907,741, and 6,698,228.

Examples of related art that discuss thin film freezing apparatuses are disclosed in U.S. Pat. Nos. 5,292,030, 5,433,967, 5,603,257, 5,473,909, 5,758,571, 5,727,713, 5,868,065, 6,698,228, 6,745,595, 6,907,741, 6,941,858, 6,952,928, 7,052,728, and 7,131,279.

### SUMMARY

Per systems and methods described herein, a cooled or chilled food product such as, for example, a beverage, or a partially-frozen or frozen food product such as, for example, ice-cream, frozen-yogurt, non-dairy frozen product, or slush, is fabricated from a product base mix, e.g., in liquid or powder form, in combination with one or more additives, such as flavorings, e.g., in liquid or powder form, and, optionally, one or more add-ins, such as frozen, solid, semi-solid and liquid food items including, for instance, candies and sundries. The product base mix is mixed and is applied or injected along one or more a cooled or refrigerated food-zone passage of a food-zone system or assembly either combined with or separately from the additive(s) and the add-in(s). Additionally, the product base mix alone or in combination with one or more flavorings is aerated with pressurized/pressurized gas injection into the food-zone passage, and/or with pressurizing and agitating the base mix alone or with one or more flavorings before or during mixing, and/or with agitation or mixing of the base mix along or with one or more flavorings before the base mix enters the food-zone passage for mixing and/or for cooling or at least partially freezing. A plunger or other tool, as described below, deploys into the food-zone passage to mix the base mix with the additive(s) and, optionally, with the add-in(s), as the mixture cools or at least partially freezes along the inner surface of the chilled or refrigerated wall(s) of the food-zone passage via thin film cooling or freezing. The plunger or other tool may be adapted to scrape or otherwise remove the mixture from the inner surface by extending axially within the food-zone passage and contacting the inner surface and optionally, rotating or pivoting about the food-zone passage. Other tools may be provided to extend axially within the food-zone passage to apply a product mix, including a base mix with or without flavorings, to at least a portion of the inner surface, to aerate the product mix, to remove or scrape a food product formed from the product mix from the inner wall, to shape the food product, to dispense the food product, and/or to clean or otherwise coat the inner surface of the food-zone passage. Systems and methods of forming a food product may include a single cooling and/or mixing chamber, as described below, or a multiple of cooling and/or mixing chambers.

A cooling and/or mixing chamber defines generally a circular cross section and configures the food-zone passage as a cylinder or tube. A cooling chamber includes a cooling mechanism for cooling or refrigerating the walls of the food-zone passage. In one embodiment, the cooling mechanism includes a coolant, such as a chilled fluid, e.g., supplied by a chiller system, a refrigerant, such as a chlorofluorocarbon, e.g., supplied by a refrigeration system, other cooling agents, e.g., a eutectic cooling composition, or cryogenic means, e.g., cryogenic systems and/or cryogenic jacket, that can help to maintain a consistent low temperature, even when confronted with a sudden thermal load when a comparatively warm base mix is applied or sprayed thereon. One or more base mix containers are provided, each containing a distinct base mix. For example, one base mix in a first container can help to provide a formulation for premium ice cream, and another base mix in a second container can be formulated for light ice cream, i.e., including a lower-fat and lower-sugar composition. In another embodiment, the second, or third containers can contain a yogurt composition for producing frozen yogurt or a non-dairy composition, e.g., a soy-based composition, for producing a non-dairy product. A conduit couples with each of the base-mix containers and leads to the cooling chamber so that a selected base mix can be pumped from its respective container into the cooling chamber.

Flavorings can be supplied in a powder, liquid, liquid-based or other form in the apparatus described herein. Alternatively, or additionally, flavor containers may be replaced with other ingredient containers containing, e.g., a nutritional or energy supplement, such as ascorbic acid (vitamin C), protein isolate, spirulina, echinacea, guarana, ginseng, ginkgo biloba, creatine, or caffeine, in a liquid or liquid-based, e.g., liquid-dispersed, form. These ingredients can likewise be selected by a customer and delivered from the containers to the cooling chamber where they are mixed with the base mix, as described above. Although the detailed description that follows generally refers to the use of flavorings in various examples, nutritional or energy supplements can substitute those flavorings in alternative embodiments.

Accordingly, the food-zone systems of the present invention may include one or more cooling or freezing chambers that can be used to produce a liquid food product, and/or an at least partially frozen food product, fresh and on demand from basic ingredients, including the base mix, per customer specifications. One or more food-zone chamber includes an interior that defines the chamber and a food passage therethrough with a cylindrical or tubular shape and defines the chamber with a circular cross-section. Alternatively, or additionally, the food-zone systems may include one or more mixing chambers that can be used to mix one or more ingredients of a food product with or without aeration. In addition, the food-zone systems may include one or more chambers that can be used as mixing chambers, as well as cooling or freezing chambers. The food-zone systems may include one or more cooling or freezing chambers and one or more mixing chambers.

In general, one aspect of the invention provides a food-zone system for preparing a chilled or at least partially frozen food product comprising at least one chamber assembly including a chamber with an interior configuration that defines a food passage extending therethrough with a cylindrical or tubular shape. The chamber is sealed along at least one end and includes an exterior wall configured as a refrigerated wall that includes an interior adapted to circulate coolant. A scraping tool operatively couples with the chamber and extends into the food passage. The scraping tool is configured such that an outer perimeter of the scraping tool contacts at least a portion of the interior configuration of the chamber. As the scraping tool moves through the food passage, the scraping tool removes or scrapes a food product mix disposed along at least a portion of the interior configuration of the chamber when the food product is chilled or at least partially frozen. The chamber defines at least one port along the chamber and includes a regulator configured to seal the chamber and to provide fluid communication between an area external to the chamber and the interior of the chamber. In one configuration, the scraping tool may be replaced with any of a variety of tools to perform different tasks of a food production cycle, including, but not limiting to, an applicator, a spray coating tool, a spin coating tool, a reservoir coating tool and a multi-head tool for application of a product mix, product mix ingredients, cleaning and/or other materials along the interior configuration of the chamber, or inner wall of the food passage.

In general, in another aspect the invention provides a food-zone system for preparing a chilled or at least partially frozen food product comprising a plurality of chamber assemblies, the chamber assemblies being arranged about a central axis. Each chamber assembly includes an interior configuration that defines a food passage extending therethrough with a cylindrical or tubular shape, and an exterior wall of the chamber being configured as a refrigerated wall including an interior adapted to circulate coolant. The system includes a tool support structure operatively coupled with the plurality of chambers and spaced from each chamber. The tool support structure is configured with one or more process tools and adapted to rotate to position the process tools relative to the chambers. Each process tool is disposed in alignment with one of the chambers and is configured to deploy within the food passage of the chamber.

Various aspects of the invention may provide one or more of the following advantages and capabilities: (1) minimal taste or color carry-over from flavor to flavor; (2) control over overrun; (3) no frost build up during operation; (4) compatibility for operation with a 110-volt power service; (5) high reliability/robustness; (6) capacity for self-cleaning, e.g., by circulation of steam and/or cleaning and/or sanitizing fluid, through the tubular food-zone system and any associated tubes, channels and passageways, and/or by storing such fluid in an associated pouch or container; (7) compact structure and resulting enablement of smaller machine size; (8) reduction in machine cost; (9) reduce cycle times between mixing and cooling or freezing of food products; and (10) increased flexibility in the manufacturing and supply-chain process.

### BRIEF DESCRIPTION OF THE DRAWINGS

FIG. 1 is a cross sectional perspective view of one aspect of a food-zone system with a chamber for mixing, aerating and/or cooling or at least partially freezing ingredients to form a food product;

FIG. 2 is a cross sectional perspective view of the food-zone system shown in FIG. 1 with a sliding end plate;

FIG. 3 is a cross sectional perspective view of the system shown in FIGS. 1 and 2 with the sliding end plate laterally displaced away from the chamber;

FIG. 4 is a cross sectional perspective of interior passages of a cooled or refrigerated wall of the chamber;

FIG. 5 is a sectional view of the refrigerated wall shown in FIG. 4 in a sectioned and flattened configuration;

FIG. 6 is a schematic illustration showing an aspect of the apparatus of the invention including a turbulence tube assembly for aerating and, optionally, flavoring and otherwise processing a base mix and delivering the base mix into the system shown in FIGS. 1-3 or alternatively into a chamber 102 of other aspects of the invention;

FIG. 6A is a schematic illustration showing an aspect of the apparatus of the invention shown in FIG. 6 including a mixing tube in place of the turbulence tube;

FIG. 7 is a cross sectional perspective view of a portion of a flavor block and a portion of the turbulence tube assembly shown in FIG. 6;

FIG. 8 is a top view of the flavor block shown in FIGS. 6, 6A, and 7;

FIG. 9 is a sectional view of the mixing tube shown in FIGS. 6, 6A, and 7;

FIG. 10 is a perspective of a multiple of flavor containers with dedicated flavor conduits coupled with peristaltic pumps;

FIG. 11 is a sectional side view of another aspect of the invention including a food preparation assembly including a chamber for thin film cooling or at least partially freezing;

FIG. 12 is a sectional side view of the assembly shown in FIG. 11;

FIG. 13 is a sectional side view of the assembly shown in FIGS. 11 and 12;

FIG. 14 is a close-up sectional side view of a portion of the assembly shown in FIGS. 11-13;

FIG. 15 is a sectional side view of another aspect of the invention including a funnel shaped food preparation assembly;

FIG. 16 is a sectional side view of the assembly shown in FIG. 15;

FIGS. 17-19 are sectional side views of a further aspect of the invention including the funnel shaped food preparation assembly shown in FIGS. 16 and 15 including a squeegee with blades in different stages of deployment;

FIG. 20-30 are perspective side views of another aspect of the invention including a chamber assembly with associated tools for mixing, applying, aerating, scraping and pushing ingredients of a food product;

FIG. 31 is a perspective view of a multiple of chambers of the assembly shown in FIGS. 11-14 or FIGS. 20-30;

FIG. 32 is a perspective view of the multiple of chambers shown in FIG. 31 with a tool support structure and a multiple receptacle structure;

FIG. 33 is a perspective view of two of the multiple of chambers shown in FIG. 31 disposed in opposite relation to one another;

FIG. 34 is a perspective view of the multiple of chambers shown in FIG. 31 and a multiple of tool support structures shown in FIG. 32; and

FIGS. 35-37 are perspective side views of another aspect of the invention including a mixing chamber with opposed pushing apparatuses.

The foregoing and other features and advantages of the invention will be apparent from the following, more-particular description. The drawings are not necessarily to scale, emphasis placed instead upon illustrating particular principles that the specification discusses below.

### DETAILED DESCRIPTION

Aspects of the food-zone systems and methods of the invention, characterized in the following descriptions and drawings, can substitute for the food-preparation assembly 22 in the apparatus and methods described in US 2006/0054614 A1 for producing a cooled or at least partially frozen food product from selected ingredients on demand per customer specification.

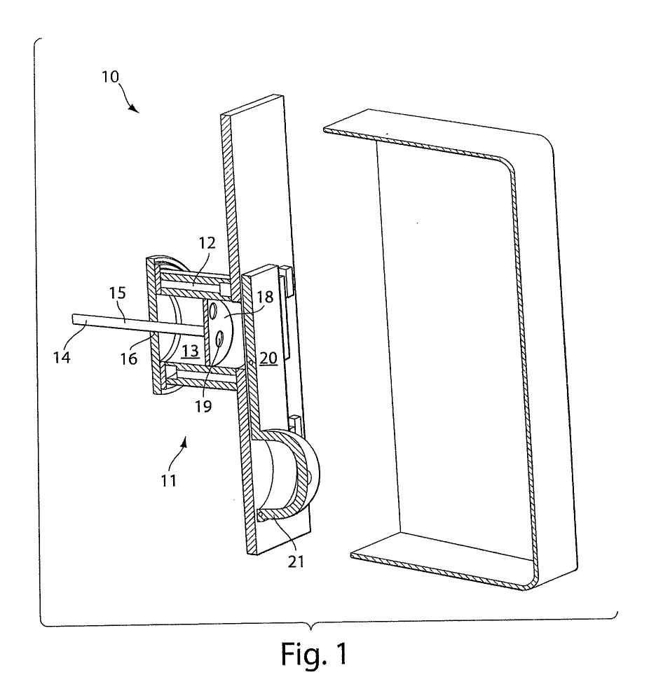

Referring to FIGS. 1-3, in one aspect the invention provides a food-zone system 10 including a cooling chamber 11 with a refrigerated wall 12 that defines a food-zone passage 13 in which a product base mix and, optionally, one or more additives, e.g., flavoring or mix-in food ingredients, are mixed. In one embodiment, the cooling chamber 11 includes an interior configuration, e.g., one or more interior walls, which defines the chamber 11 and/or the food-zone passage 13 as a cylindrical or tubular shape and defines the chamber 11 with a generally circular cross-section. Within the food-zone passage 13, a plunger 14 is constructed and arranged for reciprocal displacement. The length and diameter of the food-zone passage 13 can be, e.g., from about 2 inches to about 12 inches, depending upon the volume of the food product to be produced. For instance, the food-zone passage 13 may have a length and a diameter to produce small volumes of food product, e.g., about 4 to about 7 oz. single servings, or a comparatively larger volumes of food product, e.g., pint size or about 16 oz. portions or quart size or about 32 oz. portion.

The plunger 14 includes a shaft 15 that extends through a bulkhead seal 16 to at least the opposite end of the food-zone passage 13, e.g., proximate the sliding end plate 20. The plunger and the shaft 15 extend at an orientation along a center axis of the food-zone passage 13, or, alternatively, extend at an orientation offset of the center axis of the food-zone passage 13.

The shaft 15 is mounted to a mixing plate 18 having a diameter that is almost the same diameter as a diameter of the food-zone passage 13, e.g., such that where food product builds up along an inside surface 12A of a wall of the food-zone passage during processing the mixing plate 18 removes or scrapes at least some of the food product therefrom. The shaft 15 is threaded and mounted through an inversely threaded orifice at one end of the food-zone passage 13 so that the threads of the shaft 15 can be mated with those of the orifice to permit the shaft 15 to be displaced axially through the food-zone passage 13. Optionally, the shaft 15 may be adapted to rotate either with or without the displacement of the shaft 15. For instance, the shaft 15 may rotate at about 200-300 rotations per minute. The invention is not limited with respect to mounting the shaft 15 with the threaded orifice as described and envisions other configurations and/or arrangements of mounting or otherwise connecting the shaft 15 to the food-zone passage 13 to enable the shaft 15 to be displaced axially through the food-zone passage 13 and, optionally, to permit the shaft 15 to rotate with or without the axial displacement of the shaft 15.

The mixing plate 18, which defines one or more strategically sized orifices 19, e.g., about 1 cm in diameter, is rotated in a clockwise and/or counter-clockwise direction by turning the threaded shaft 15 to which it is attached. The base mix, e.g., aerated or not aerated, and, optionally, one or more flavorings, e.g., aerated or not aerated, are introduced into the food-zone passage 13. The food-zone passage 13 is sealed at both ends and pressurized with air. As the mixing plate 18 and shaft 15 rotate, they advance and retract through the base mix and flavoring at a rate, e.g., of approximately one-eighth of an inch per revolution. This spinning and longitudinal movement splashes the fluid, e.g. base mix and flavoring, against the inside of the refrigerated wall(s) 12 against which it is cooled or at least partially freezes.

As the mixture begins to cool or at least partially freeze along the inside surface 12A of the refrigerated wall 12, the mixing plate 18 scrapes off the product from the wall 12 as it spins, while moving back and forth, and additionally captures the stiffening mixture between the spinning mixing plate 18 and the walls at each end of the food-zone passage 13. Accordingly, the food product forces through the orifices 19 in the mixing plate 18 and thereby works or mixes as the mixing plate 18 moves. It is believed that because this aggressive working of the mixture occurs in a pressurized environment, overrun can be varied and uniformly blended through the product. Overrun may include an increase in the percentage of volume of the base mix and flavoring(s) by introduction of gas, e.g. air, into the base mix and flavoring(s). The introduction of air is because of, for instance, the mixing plate 18 mixing of the base mix and flavoring(s). Control of the amount of overrun, at least in part, is a function of controlling the amount of air incorporated into the base mix and flavoring(s). It is also believed that at least higher pressure and/or longer mixing time may result in greater amounts of overrun.

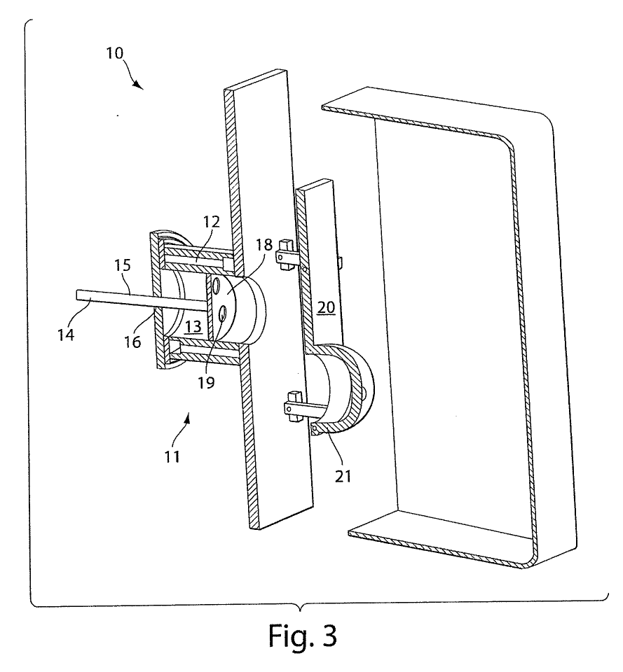

As shown in FIG. 1, a sliding end plate 20 releasably locks into a closed position as the food-zone passage 13 fills with the base mix and flavoring(s) that mix and cool or at least partially freeze. After the product is sufficiently cooled or at least partially frozen in the food-zone passage 13, the sliding end plate 20 is slid upward to open the end food-zone passage 13 so that the plunger 14 can push the food product out of the passage and into a rounded shaping cavity 21, which will shape the food product into a desired shape, e.g., scoop shape. The sliding end plate 20 displaces away from the passages, as shown in FIG. 3, to allow the cavity 21 to permit the food product to eject from the cavity 21 for serving the food product to a customer.

In one embodiment, an elastic, displaceable diaphragm (not shown) can extend across the perimeter of the cavity 13, or along the inside surface of the wall 12, to help to eject the formed food product from the cavity 13. The food product pushes the diaphragm into the cavity 13. Gas may then inject through a vent (not shown) into the cavity 13 to push the diaphragm back out of the cavity 13 such that as the diaphragm ejects, the food product ejects from the cavity 13.

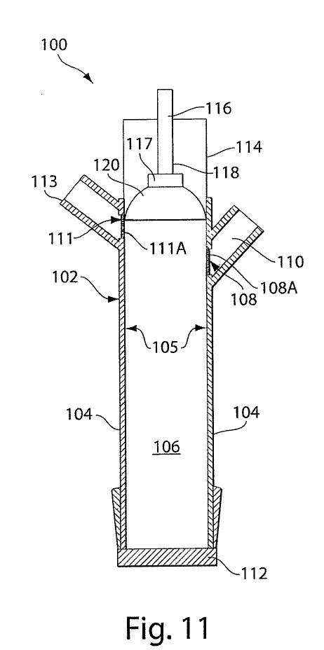

The invention is not limited to the orientation of the food-zone system 10 shown in FIG. 1 and anticipates that other orientations, such as, for instance, that shown in FIG. 11, is possible.

A second plate (not shown) can be mounted in the food-zone passage 13, e.g., to the left or of the mixing plate 18, and can be displaced with the mixing plate 18 to effectively seal the orifices 19 in the mixing plate 18 to prevent the food product from flowing back through those orifices 19 as the food product is discharged. Additionally, the threads on the shaft 15 can extend only around a portion of the diameter of the shaft 15, and the inverse threads in the orifice at the bulkhead seal 16 can be displaced so that the shaft 15 can be un-coupled from its mount in the threaded orifice, allowing the shaft 15 to be axially displaced along the food-zone passage 13 without rotation when the food product is to be ejected from the food-zone passage 13.

As mentioned, the volume of food product produced can range from single serving volumes, e.g., of about 4 to about 7 oz., to comparatively larger masses or volumes of food product, e.g., of from about 16 oz. to about 32 oz. portions or larger. In one embodiment, the food-zone system 10 and the cooling chamber 11 are a packer tubular food-zone system 10 and a packer cooling chamber 11 that are adapted to accommodate and to mix larger volumes of the base mix and flavoring(s) to produce comparatively larger volumes of food product. In this case, the dimensions of the food-zone passage 13, the plunger 14 and its shaft 15, the mixing plate 18 and its orifices 19, and, optionally, the second plate to seal the orifices 19, are sized to accommodate the introduction and mixing of larger volumes of the base mix and flavoring(s) and to incorporate sufficient aeration into the base mix and flavoring(s), where an aerated food product is to be produced, and to provide sufficient overrun to ultimately produce comparatively larger volumes of food product. The packer tubular food-zone system 10, the packer food-zone passage 13, the packer cooling chamber plunger 14, and the packer mixing plate 18 are operate substantially similarly as described above.

Production of comparatively larger volumes of food product, such as pint or quart-sized batches, may be produced in sequential batches whereby a first volume of the base mix and flavoring(s), e.g., aerated or not aerated, are mixed within the packer food-zone passage 13 using the packer plunger 14, to mix and/or to incorporate sufficient air/aeration into the first volume, to thereby produce sufficient overrun as is required or desired, and to produce a first batch of food product that is the packer food-zone passage 13 dispenses into a container. Second and additional volumes of the base mix and flavoring(s), e.g. aerated or not aerated, may be subsequently and sequentially added and processed within the packer food-zone passage 13, as described, to produce second and additional batches of food product until the required or desired volume of food product is achieved and is dispensed into the container. The packer plunger 14 and its shaft 15 may be adapted such that at least a portion of the shaft 15 and/or the mixing plate 18 extend from and exit the packer food-zone passage 13 and are received by at least a portion of the container into which the food product is dispensed so that the mixing plate 18 can push down or otherwise pack the food product into the container.

For all volumes of food product to be produced, at least the size of the food-zone passage 13, the length of the food-zone passage 13, the temperature of the refrigerated wall 12, the residence time of the base mix and flavoring in the food-zone passage 13, the cycle time of the mixing with the plunger 14, the extent of aeration of the base mix and flavoring, the volume of overrun produced and/or the freeze characteristics of the base mix and flavoring affect the extent of freezing of the base mix and flavoring and the frozen textures, consistencies and properties of the resulting food products.

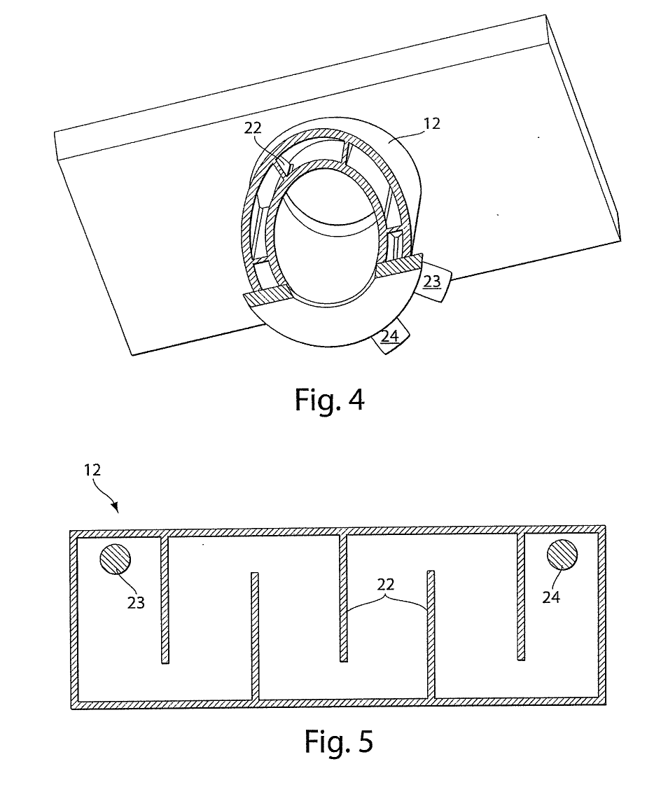

Referring to FIG. 4, the refrigerated wall 12 of the cooling chamber 11 is hollow and includes dividers 22 to create a tortuous pathway for the coolant through the wall 12 from an inlet port 23 to an outlet port 24. If the wall 12 includes sections, and one flattens the wall 12, its inner structure would appear as shown in FIG. 5. The wall 12 can be formed, e.g., of a thin aluminum sheet. The wall 12 also includes one or more ports (not shown) passing through the wall 12 through which the base mix and flavoring are injected (separately through different ports or together through the same port) into the food-zone passage 13.

The food-zone system 10 and the cooling chamber 11, and the packer food-zone system 10 and the packer cooling chamber 11, as shown in and described with reference to FIGS. 1-5, may comprise one of multiple systems 10 and chambers 11. For instance, in FIGS. 1-3, the cooling chamber 11 and the sliding end plate 20 may be disposed in a substantially vertical orientation. Similarly, two or more cooling chambers 11, or a multiple of cooling chambers 11, may be arranged in a substantially vertical orientation, wherein one cooling chamber 11 is disposed above or below another cooling chamber 11 and, optionally, the sliding end plate 20 includes additional shaping cavities 21 to accommodate more than one cooling chamber 11. The sliding end plate 20 would slide vertically, e.g., in an upward and/or a downward orientation, and dispose the shaping cavity 21 to align with the cooling chamber 11 in operation. Similarly, two or more cooling chambers 11, or a multiple of cooling chambers 11, may be arranged in a substantially horizontal orientation with one cooling chamber 11 adjacent another, or may be arranged in a vertical or horizontal circular orientation whereby each of the cooling chambers 11 is disposed around a circumference of a circular configuration that the multiple of chambers 11 defines. In this case, the sliding end plate 20 defines a circular profile and surrounds the circumference that the multiple cooling chambers 11 define.

The food product produced in the cooling chamber 11 can be produced, e.g., from base mix (including, e.g., milk, butterfat, and sugar); flavoring (such as vanilla, chocolate, strawberry, etc.), and gas dispersed there through. In other embodiments the base mix is a non-dairy (e.g., water-based or soy-based) composition; and the food product can be a chilled or at least partially frozen product, (e.g., slush, beverages, frappes, shakes) or a substantially frozen product (e.g., ice cream or frozen yogurt) and therefore may include a wide spectrum of food products from chilled products, such as beverages, to substantially frozen products, such as ice cream, with a range of partially frozen products, such as slush, there between. Optionally, carbon dioxide can also inject into the cooling chamber 11 to carbonate the product. The refrigerated wall(s) 12 in the cooling chamber 11 cools or at least partially freezes the flavored base mix or portions thereof to form a food product. “Frozen” food product refers to at least a partially frozen product and may include fluid products with a substantial portion of the composition remaining in liquid form. Optionally, one or more solid-food mix-in additives, e.g., fruits, nuts, candies, sundries and portions thereof, can be added into the food-zone passage 13 along with the base mix and flavoring.

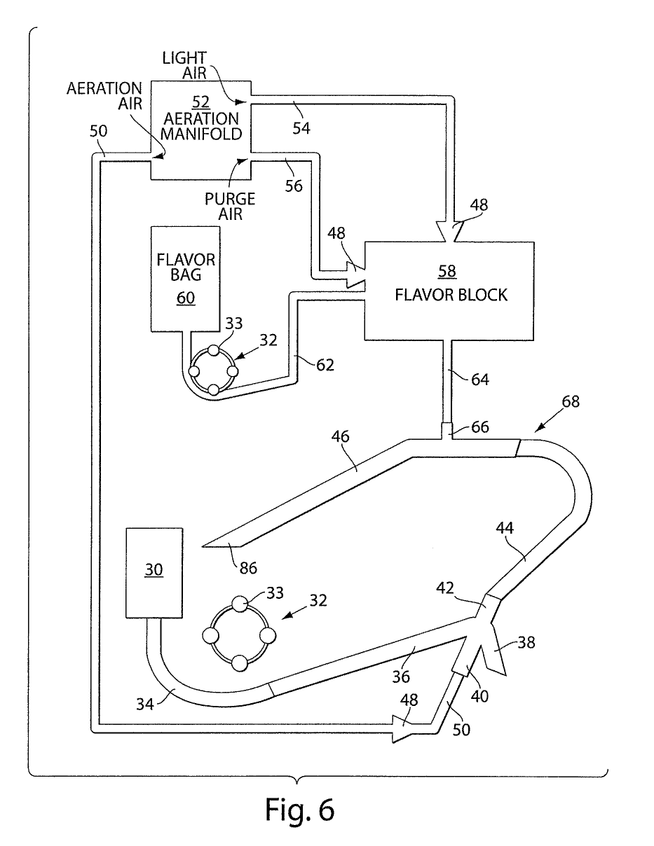

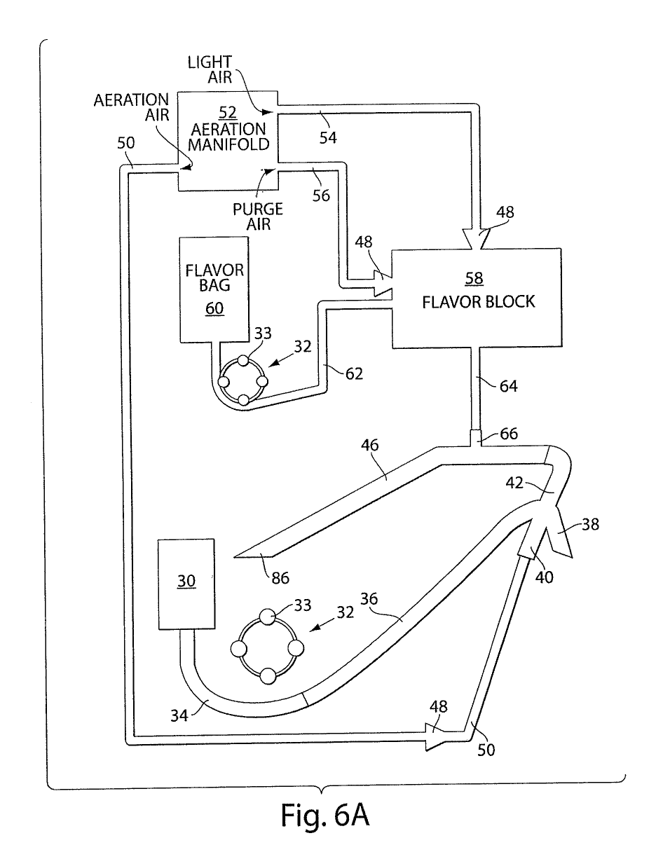

FIG. 6 shows a schematic illustration of one embodiment of an apparatus for adding flavoring to the base mix, optionally aerating the base mix, and portioning or spraying the flavored and aerated or non-aerated base mix into a cooling chamber 11. The base mix is stored in a container 30, e.g., an otherwise-sealed plastic bag, with an outlet port 24 to which a base-mix conduit in the form of flexible tubing 34 couples. (Where the specification references components, such as conduits, couple or join with other components, such as ports, the coupled components can be in the form of two discrete components or can be parts of a unitary structure.) In the illustrated embodiment, the base mix is in a liquid form in container 30. The base mix is drained from the container 30 using a peristaltic pump 32, which comprises a plurality of shoes or rollers 33 about its perimeter such that, when the pump is rotated, the shoes 33 drive the base mix through the flexible tubing 34 (which, like other conduits in this apparatus, can have an inner diameter of ¼ inch) toward a crow's-foot fluid junction 42, e.g., at about 25 milliliters/minute. The flow rate is a function of at least the viscosity of the base mix, the size of the serving and/or the freeze characteristics.

In another embodiment (not shown), the base mix is in a solid, particulate or powder form in container 30, and the container 30 is coupled with a conduit that is coupled with a liquid source, such as a water mains or a container of water under pressure, wherein the flow of liquid from the source is regulated via a valve, as described in U.S. Ser. No. 10/884,683 (US 2006-0003065 A1), “Dry-Base Aerated Food Product Dispensing Method and Apparatus,” which is incorporated herein by reference in its entirety. In this embodiment, the container 30 includes a metering device, such as a screw feeder. The screw feeder includes an auger coupled with an electronically controlled step motor, wherein the auger is rotatably mounted in a housing. Each time the auger turns by the motor through a given angle, a selected amount of base mix from the container 30 is dispensed into the liquid in the adjoining conduit and dissolved therein to form a liquid base mix, which feeds subsequently to the flavor block 58. The conduit can be designed to produce turbulence, such as via a turbulence tube assembly 68, described infra, to mix the base mix into the liquid to facilitate dissolution of the powder. Additionally, the temperature of the liquid can be elevated to increase the solubility of the base mix therein.

As shown in FIG. 6, the junction 42 is formed, e.g., of metal or plastic, and defines intersecting passages for fluid flow therein. As shown, the shoes 33 of the peristaltic pump 32 rotate counterclockwise to compress the portion of the flexible tubing 34 with which they are in contact at any given moment to thereby push the base mix via positive displacement into a first base-mix input port 36, while generating a vacuum upstream of the pump 32, which draws out more of the base mix from container 30. An advantage of using the peristaltic pump is that the pump 32 does not contaminate the fluid (i.e., the base mix) flowing through the conduit and because the fluid, in turn, does not contaminate the pump 32.

One or more additional base-mix input ports 38 are likewise provided in the crow's-foot fluid junction 42. To each additional port 38 (though not shown) is coupled flexible tubing with a peristaltic pump and a container filled with a distinctive base mix, configured as in the first set of components 30, 32 and 34 coupled with the first base-mix input port 36. Accordingly, in one embodiment, a first container 30 supplies a “premium” ice-cream base mix through the first base-mix input port 36, while a “light” or low-fat version of the base mix is pumped from a second base-mix container through the second base-mix input port 38. The light version of the ice-cream base mix has a lower fat content (e.g., half as much fat or less than the “premium” mix) and no added sugars beyond those naturally found in the base ingredients (e.g., lactose in the milk). The light version may include alternatively or additionally sugar alcohols, natural or artificial sweeteners and/or natural or artificial dietetic sweeteners. Alternatively or in addition, base mixes for other types of food product (e.g., for frozen yogurt as well as for non-dairy food products—e.g., soy-based products) are respectively stored in base-mix containers.

In addition to the base-mix input ports 36 and 38, the crow's-foot fluid junction 42 may also include a gas-input port 40. The gas-input port 40 is coupled with a first gas conduit 50 from a check valve 48 that controls the flow of gas (for aeration of the base mix) from a gas manifold 52, e.g., an air manifold, which provides air, e.g., at 40 pounds per square inch, to a number of conduits in the system. In one embodiment, the manifold is an oil-less piston pump manufactured, e.g., by Gast Manufacturing, Inc. of Benton Harbor, Mich., USA. The check valve 48 also prevents fluids from flowing back toward the manifold 52 from the crow's-foot fluid junction 42. In one embodiment, aeration air from the manifold 52 flows through the first gas conduit 50 at 70 standard cubic feet per minute, then through check valve 48, and then through the gas-input port 40 into the junction 42 where the aeration air mixes with the base mix from container 30 or from one of the other containers coupled with the junction 42.

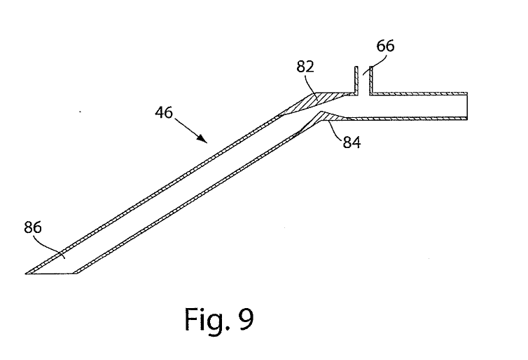

Referring to FIG. 9, and with further reference to FIG. 6, in one embodiment, the aerated base mix and flavoring mix within a turbulence tube assembly 68 before application or injection into the cooling chamber 11. The turbulence tube assembly 68 includes respective input ports for the base mix and flavoring in fluid communication with an interior passage having, e.g., a generally circular cross section. Upon exiting the turbulence tube assembly 68, the flavored base mix flows to the cooling chamber 11. The turbulence tube assembly 68 includes a turbulence tube 44 and a mixing tube 46. The mixing tube 46 includes restrictive bodies 82 and 84 defined within its interior passage to help to increase the turbulence of fluids passing there through and thereby to help to improve mixing of fluids.

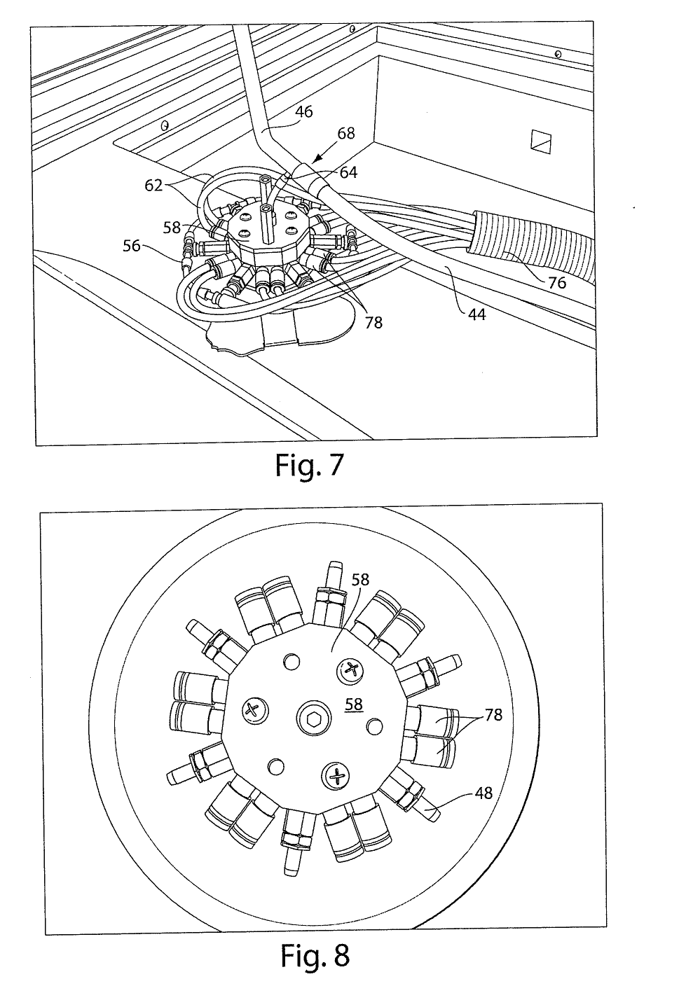

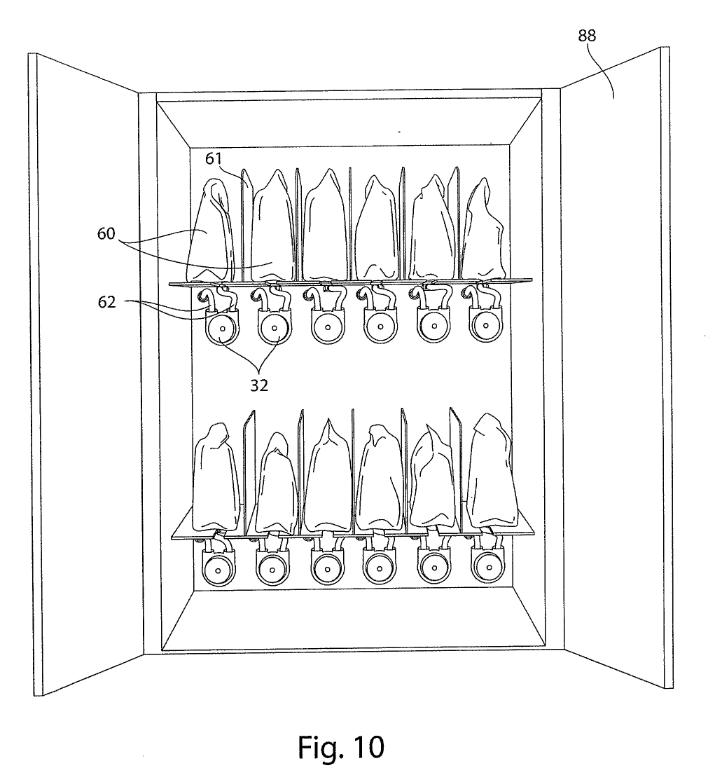

Referring to FIG. 7, the mixing tube 46, e.g., constructed of a hard or a flexible plastic, includes a flavor-input port 66 to which is coupled a common flavor conduit 64 extending from a flavor block 58. In one embodiment, the flavor block 58, in turn, couples with a plurality of dedicated-flavor conduits 62. Each conduit 62 is coupled with a respective flavor container 60, e.g., in the form of an otherwise-sealed plastic bag, as shown in FIG. 10, and is in contact with a peristaltic pump 32 configured to draw a selected flavoring from the flavor container 60 through the dedicated-flavor conduit 62 and through the flavor block 58 at a rate of, e.g., about 35 milliliters per minute. The peristaltic pump 32 for the flavoring operates in the same manner as the peristaltic pump for the base mix, described above. From the flavor block 58, the selected flavoring flows through the common flavor conduit 64 and then through the flavor-input port 66 into the turbulence tube assembly 68.

A light flow of gas from a second gas conduit into the flavor block can facilitate flow of the flavoring through the flavor block. More specifically, introduction of the light gas flow pushes the flavoring through the flavor block at a faster rate, enabling better mixing of the flavoring and base mix downstream in the turbulence tube assembly 68. A common flavor conduit (through which each selected flavor flows) provides a passage for the flavoring to flow from the flavor block to the turbulence tube assembly 68 where the flavoring mixes with the aerated base mix. Alternatively, separate conduits can join the flavor containers directly to the cooling chamber 11.

The flavor block 58 also includes respective check valves 48 coupled with the second and third conduits 54 and 56 for the light gas flow and for purging, respectively, from the air manifold 52. In one embodiment, the gas supplied (through all gas conduits) from the air manifold 52 is air. The light flow of pressurized gas through the second gas conduit 54 is at about 10 cubic feet per minute and is mixed in a low volume with the flavoring in the flavor block to help push the flavoring through the flavor block 58; internal passages in the flavor block 58 from the check valves 48 for the light gas flow and from the flavor-input ports form a junction inside the flavor block 52 to permit intermixing with the flavoring flowing there through.

Referring to FIG. 6A, in another embodiment, the apparatus for aerating and adding flavoring to the base mix and then portioning/spraying the aerated and flavored base mix into a cooling chamber 11 excludes the turbulence tube system 68 shown and described with reference to FIG. 6 and includes only the mixing tube 46. The fluid junction 42 operatively connects to the portion, e.g., straight portion, of the mixing tube 46 upstream of the connection of the mixing tube 46 with the flavor-input port 66. The check valve 48 is in a close positioned, or the gas conduit 50 is detached from the fluid junction. In this embodiment, pressurizing the cooling chamber 11 achieves aeration.

Referring to FIGS. 7, 8 and 10, in one embodiment, a plurality of flavor containers 60 are provided, each coupled with a respective dedicated-flavor conduit, which couples with a respective flavor-input port, as shown as 78 in FIG. 8, on the flavor block 58. Each of the flavorings in the respective containers 60 is a liquid-based solution or dispersion. The different flavorings included in the containers 30 can include natural and/or artificial flavorings, such as vanilla, chocolate, strawberry, banana, caramel, pistachio, butter pecan, maple, coffee, mango, cake batter, black raspberry, cotton candy, etc.

In another embodiment, the above-described flavor containers are replaced with other liquid-ingredient containers containing, e.g., a nutritional or energy supplement, such as ascorbic acid (vitamin C), protein isolate, spirulina, echinacea, guarana, ginseng, ginkgo biloba, creatine, or caffeine, in a liquid or liquid-based (e.g., liquid-dispersed) form. In still another embodiment, the additional ingredient(s) (e.g., nutritional or energy supplement) is/are added in a dry particulate or powder form to the base mix in the same or similar manner as to the way that a dry particulate material or powder is added to a liquid (in that case, e.g., water) in U.S. Ser. No. 10/884,683, “Dry-Base Aerated Food Product Dispensing Method and Apparatus” (P. Kateman), filed Jul. 1, 2004.

In one embodiment, the cooling mechanism in the refrigerated wall(s) 12 of the cooling chamber 11 includes a eutectic fluid for rapid cooling. The exposed freeze surface of the refrigerated wall 12 can be 18-gauge stainless steel underneath which is one or more cavities filled with a eutectic composition that melts at a temperature below the freezing temperature of the flavored base mix; for example, the eutectic composition can have a melting point of about 0° F. and can be in the form of a glycol-based solution. Alternatively, the eutectic composition can be a saline solution or any composition with the desired melting point. The refrigerated wall 12 can also include copper tubing for cooled refrigerant, such as chlorofluorocarbon, traversing through the cavities in which the eutectic material is contained to re-freeze the liquid phase of the eutectic composition or to maintain the eutectic composition in a solid state.

Vapor-compression refrigeration system connected via the copper tubing can cool the refrigerant. The copper tubing leaving the wall 12 of the cooling chamber 11 may couple with a compressor that compresses refrigerant gas as it leaves the cooling chamber 11. The compressed refrigerant gas can then be directed into a condenser in which heat transfers from the gas to, e.g., ambient air; the refrigerant gas liquefies as it cools. After liquefying, the refrigerant passes through an expansion valve, with a consequent pressure drop, thereby further cooling the refrigerant. The cooled refrigerant can pass through the copper tubing in the wall 12 of the cooling chamber 11 again, where heat is again extracted from the eutectic composition to the refrigerant to re-freeze the eutectic composition and to vaporize the refrigerant.

In this case, heat from the aerated and flavored base mix is extracted by the eutectic composition contained in the refrigerated wall 12, which utilizes the heat energy from the flavored base mix to convert the eutectic composition from solid to liquid state with little change in its temperature. Meanwhile, this extraction of heat causes the aerated and flavored base mix to freeze against the refrigerated wall 12. More heat will simply result in more of the eutectic composition melting, but still with little change in the temperature of the eutectic composition or in the temperature of the refrigerated wall 12.

Alternatively, a chilled fluid may circulate as described that a chiller system supplies that is operatively coupled to the cooling chamber 11.

Referring to FIG. 10, the peristaltic pumps 32 for the respective flavor containers can be governed by a programmable logic controller. Each of the flavor containers 60 resides in a respective bay between vertical dividers 61 on a base platform. As shown, this embodiment includes an upper and lower row of bays. The dedicated-flavor conduits 62 wrap around the right side of each peristaltic pump 32 and back up from the left side of each peristaltic pump 32 through a respective port in the back wall beneath each respective bay.

FIG. 7 shows the turbulence tube assembly 68 unmounted from the flavor block 58. The different dedicated-flavor conduits 62 have clear walls defining interior passages with an inner diameter of 3/32nds of an inch, and the colors of the flavorings are revealed through the conduits 62. The dedicated-flavor conduits 62 are bound in a flexible sheath 76 between the peristaltic pumps 32 and the flavor block 58. The third gas conduit 56 for purging and the second gas conduit 54 for the light flow of gas (underneath the flavor block and, therefore, not shown in FIG. 7) also are fed through the flexible sheath 76. As shown, the third gas conduit 56 for purging forms a ring around the flavor block 58 through which gas is pumped at about 40 pounds per square inch and at about 70 standard cubic feet per minute, with spoke conduits extending inward from the ring to the check valves 48. The check valves 48 and the flavor-input port 78 can be better seen in FIG. 8, which shows the flavor block 58 mounted in the bottom half of a casing 80. The flavor-input port 78 contains a diaphragm to prevent back flow of flavoring or gas out of the flavor block 58.

With reference to FIG. 9, the interior structure of the mixing tube 46 is shown in a cross sectional view. A pair of restrictive bodies 82 and 84 is mounted inside the tube 46 at an optional bend downstream from where the flavoring is fed through the flavor-input port 66 into the tube 46 to be mixed with aerated base mix. The restrictive bodies 82 and 84 produce a constriction in the tube 46, resulting in a Venturi effect, wherein the velocity of the flavoring and base mix increases through the constriction, reducing the pressure and producing a partial vacuum through the constriction via the Bernoulli effect. This partial vacuum also helps to draw the flavoring through the flavor-input port 66 and into the mixing tube 46. The restrictive bodies 82 and 84 in combination with the bend serve to mix thoroughly the flavoring with the base mix before discharge from the mixing tube 46 through the orifice 86 without significantly compromising the aeration of the base mix. In one embodiment, the diameter of the passage defined in the mixing tube 46 is about 0.375 inches before and after the restrictive bodies 82 and about 84 and 0.170 inches between the restrictive bodies 82 and 84. As shown in the illustrated embodiment, the lead-in and exit angles on the restrictive bodies can be about 30°. In another embodiment, the bend in the mixing tube 46 is omitted, and the restrictive bodies are mounted in a straight section of the tube 46, though proximate to the flavor-input port 66 and between the flavor-input port 66 and the discharge orifice 86.

Because different flavorings are selected and fed through the flavor block 58, through the common flavor conduit 64, and then through a common flavor region in the mixing tube 46 for different orders placed by a sequence of customers, each of these components, through which all flavorings pass, is cleaned between portioning of the base mix and flavoring via passage of pressurized gas there through, as is further discussed, below. Accordingly, it is advantageous to keep the common flavor region of the mixing tube 46 as short as is practicable while still maintaining adequate mixing of the flavoring and base mix in the tube 46 of the turbulence tube assembly 68 to limit the interior surface area that would require cleaning. In one embodiment, the common flavor region of the mixing tube 46 is about 3 inches, while the full length of the turbulence tube assembly 68 is about 30 inches.

Cleaning (e.g., between portionings/sprayings of the base mix and flavoring) of the flavor block 58, the common flavor conduit 64, and the mixing tube 46 of the turbulence tube assembly 68 from the flavor-input port 66 through the discharge orifice 86 is performed by directing gas at high pressure (e.g., at 40 pounds per square inch) from the air manifold 52 through the first gas conduit 50 and/or the second gas conduit 54 into and through the flavor block 58 and then through the mixing tube 46. The commencement of the gas flow from the air manifold 52 for purging is likewise triggered by the programmable logic controller via software code with instructions for sending the commencement signal to the air manifold 52 after the pumps 32 are shut down. During purging, the gas accordingly sweeps away most of the flavoring from the passage walls along its path of travel (before the gas enters the turbulence tube assembly 68). The cleaned components are then ready for processing of another order including a different flavor selection with little, if any, contamination from the flavoring in the preceding order.

In the automated machine described in US 2006/0054614 A1, the peristaltic pumps 32 can be coupled with the flexible tubing 64 coupled with the flavor containers 60 in the automated machine. As another example, the flavor block 58, described herein, can be substituted for the flavor selection assembly in the apparatus described in U.S. Ser. No. 11/140,624. Additionally, the turbulence tube assembly 68 is likewise useful in the apparatus of U.S. Ser. No. 11/140,624 and can likewise be coupled to the substituted flavor block 58 (and mounted in a food-preparation cover surrounding the freeze surface 14) in the apparatus to dispense the aerated and flavored base mix onto the freeze surface 14.

In another embodiment of the automated machine of US 2006/0054614 A1, a second turbulence tube having a larger cross section for its inner passage is used in conjunction with the first turbulence tube 44 or with the mixing tube 46. For example, chocolate or mocha flavoring, in particular embodiments, has a higher viscosity and is needed in a larger volume for each food product serving compared with other flavorings, such as vanilla, strawberry, banana, etc. Accordingly, the conduit leading from the container filled with chocolate flavoring is likewise coupled with a peristaltic pump, though the conduit is separately routed to the flavor-input port of the second turbulence tube. The same or similar base mix containers are likewise coupled with both the first and second turbulence tubes.

Referring to FIGS. 11-14, in another aspect the invention provides a chamber assembly 100 that can substitute for the food-preparation assembly 22 described in the apparatus of U.S. Patent Application Publication No. 2006/0054614 A1 noted above. The assembly 100 includes at least one chamber 102 that receives various dispensed ingredients of a food product for mixing, blending, aerating, and/or cooling or at least partially freezing to form the food product. The chamber 102 may be constructed and arranged to perform a specialized task, e.g., cooling or at least partially freezing, in processing the food product ingredients. Alternatively, or additionally, the chamber may be constructed and arranged to perform a number of process tasks, e.g., mixing food product ingredients and cooling or at least partially freezing ingredients, temporally serving as both mixing and cooling or freezing chambers in a dedicated or serialized manner. Further, one or more chambers 102 may be configured and arranged as a multiple of chambers 102, wherein each chamber 102 performs a specialized task and dispenses product ingredients during processing into a second chamber 102 for further processing, and/or dispenses a formed food product into a second chamber 102 or from the assembly 100 to a food product container or receptacle, e.g., for storing or serving.

In addition, the chamber 102 may be constructed and arranged to help to provide wider control over pressure within the chamber 102 and to help to control aeration of food product ingredients or a food product mix to obtain a range of consistencies, textures, and properties of the final food product. Pressure may be controlled with use of one or more valves or other flow regulators, as described below, that may be coupled with the chamber 102 to help to regulate volume and flow of pressurized gas, e.g., air, into the chamber 102 to help to pressurize the interior of the chamber 102 and/or to help to aerate a product mix used to form the food product or product mix ingredients. Pressure may be alternatively or additionally controlled with use of one or more pushing tools and/or application tools, as described below, that are deployed and moved, e.g., reciprocally, within the chamber 102 to mix, blend and/or agitate, e.g., for a configurable amount of time, a product mix or product mix ingredients and pressurized gas. In addition, a pushing and/or application tool may alternatively or additionally rotate or pivot about an axis central to the tool to mix, blend and/or agitate the product mix or product mix ingredients alone or with pressurized gas.

Alternatively, or additionally, the chamber 102 may be constructed and arranged to process a product mix or product mix ingredients without aeration or addition of air or pressurized air to thereby serve as a mixing and/or freezing chamber.

In various embodiments of the assembly 100, pushing and application tools may be disposed externally from the interior of the chamber 102 and, when required, deploy within the chamber interior 102. Alternatively, pushing and application tools 117 and 122 may be connected or otherwise operatively coupled with the chamber 102 to dispose the pushing and application tools 117 and 122 within the interior of the chamber 102. In addition, the pushing and application tools 117 and 122 may be constructed and arranged with any of a variety of shapes to achieve a particular task, e.g., scraping or removing product mix from the chamber 102, pushing product mix from the chamber 102 for dispensing, forming the product mix prior to dispensing from the chamber 102 to product a food product with a desired or required shape, coating the interior of the chamber 102, and/or cleaning the interior of the chamber 102.

The assembly 100 includes a cooling chamber 102 with a refrigerated wall 104 that defines a food-zone passage 106 into which an aerated or non-aerated product mix or ingredients of a product mix including, for example, a product base mix, one or more flavorings, and, optionally, one or more add-ins, e.g., frozen, solid, semi-solid and/or liquid food items and/or supplements, are dispensed or applied. An inner wall 105 of the cooling chamber 102 defines the food-zone passage 106 with a cylindrical or tubular shape and defines the chamber 102 with a generally circular cross-section.

The cooling chamber 100 may be constructed and arranged to receive an aerated or non-aerated product mix comprising the product base mix blended with one or more flavorings. In this case, the cooling chamber 100 may serve as a cooling chamber that cools or at least partially freezes the product mix within the food passage 106 and/or along at least a portion of the inner wall 105 when the mix is applied to the wall 105 for cooling or at least partially freezing before dispensing the food product from the chamber 100. The product mix may be applied to the inner wall 105 as a thin film or layer. Alternatively, the cooling chamber 100 is constructed and arranged to receive separately the product base mix and one or more flavorings and, optionally, one or more add-ins for mixing these ingredients to form the product mix and for cooling the formed product mix. In this case, the cooling chamber 100 may serve as a mixing and a cooling/freezing chamber, wherein the product base mix and one or more flavorings and, optionally, one or more add-ins, are mixed or blended together within the food passage 106 and are cooled or at least partially frozen within the food passage 106 and/or along the inner wall 105. Cooling or at least partially freezing may occur simultaneously with mixing the ingredients to form the product mix or may occur subsequently to forming the product mix.

In addition, the cooling chamber 102 may be constructed and arranged to receive a product mix that has been aerated before introduction into the food passage 106 with, for example, the turbulence tube assembly 68 shown in FIG. 6, the mixing tube 46 shown in FIG. 6A, or other aeration system or method. In this case, the cooling chamber 100 may serve as a chilling/freezing chamber and receives the aerated product mix for application along at least a portion of the inner wall 105 to cool or at least partially freeze the product mix. Optionally, the chamber 102 may effect additional mixing or agitation of the product mix to help to achieve further aeration of the product mix. Alternatively, or additionally, the cooling chamber 102 may be constructed and arranged to receive aerated ingredients of a product mix including an aerated product base mix and aerated flavoring(s) that have been aerated before introduction into the food passage 106 with the turbulence tube assembly 68, the mixing tube 46 or other aeration system or method. In this case, the cooling chamber 102 receives the aerated product base mix and flavoring(s) for mixing to form an aerated product mix for application along at least a portion of the inner wall 105 to cool or at least partially freeze the product mix. Cooling or at least partially freezing may occur simultaneously with mixing or subsequent to mixing of the ingredients. The aerated ingredients or the aerated product mix may receive additional mixing or agitation to help to achieve further aeration of the product mix.

Further, as described below, the cooling chamber 102 may be constructed and arranged to serve as a pressurized chamber 102 to create a pressurized food-zone passage 106 within which an aerated or non-aerated product mix or product mix ingredients are mixed or agitated under pressure to help to aerate the product mix and to help to form the food product. In this case, the cooling chamber 102 may serve as a mixing chamber as well as a cooling chamber. As mentioned, cooling or at least partially freezing the product mix may occur simultaneously with mixing or agitation of the product mix or product mix ingredients or subsequent to such mixing.

In another embodiment, the chamber 102 may be constructed and arranged to serve exclusively as a cooling chamber to cool or at least partially freeze one or more thin layers of an aerated or non-aerated product mix or product mix ingredients along at least a portion of the inner wall 105, without provision for mixing, blending or agitation of the product mix or ingredients. In yet another embodiment, the chamber 102 may be constructed and arranged to serve exclusively as a mixing chamber to mix or blend an aerated or non-aerated product base mix with one or more aerated or non-aerated flavorings and, optionally, one or more add-ins to form an aerated or non-aerated product mix, without provision for cooling or at least partially freezing the product mix or ingredients along the inner wall 105. In this case, the chamber 102 would not require the refrigerated wall 104, but, could optionally include a jacketed, insulated or other temperature-controlled wall 104 to help to maintain certain temperatures within the food passage 106 during product formation, if required or desired. In either embodiment, the chamber 102 may include provisions, as described below, for the introduction of pressurized gas, e.g., air, to help to pressurize the food passage 106 and/or to add pressurized gas to help to aerate the product mix or product mix ingredients dispensed into the food passage 106 during formation of the food product.

The assembly 100 includes at least one inlet port 108 defined in the wall 104 and connected to an inlet conduit 110 whereby the port 108, the interior of the inlet conduit 110 and the food-zone passage 106 are in fluid communication. A valve or other flow regulator 108A may couple with the inlet port 108 to help to close and to help to regulate flow of fluids, semi-solids and/or solids from the inlet conduit 110 through the inlet port 108 into the food-zone passage 106. In one embodiment, the inlet conduit 110 and the inlet port 108 may be constructed and arranged to serve as an inlet port for an aerated or non-aerated product mix or product mix ingredients, such as a product base mix and flavoring(s). In another embodiment, the inlet conduit 110 and the inlet port 108 may be constructed and arranged to serve as an inlet port through which ingredients such as add-ins, e.g., fluid, semi-solid and solid food products including, but not limited to fruit, fruit sections or bits, candies, nuts, and sundries, are added into the food-zone passage 106.

Alternatively, or additionally, in another embodiment, the inlet conduit 110 and the inlet port 108A may be constructed and arranged to serve to supply and to deliver pressurized gas, e.g., air, into the food-zone passage 106 to pressurize the cooling chamber 102 and the food passage 106 to help to aerate the product mix or product mix ingredients. In this case, the valve or flow regulator 108A coupled with the inlet port 108 is configured to help to regulate flow of pressurized gas, e.g., air, from an external pressurized gas supply.

In another embodiment, the assembly 100 may include at least a second inlet port 111 defined in the wall 104 and connected to an inlet conduit 113 whereby, the port 111, the interior of the inlet conduit 111 and the food-zone passage 106 are in fluid communication. A valve or other flow regulator 111A may couple with the inlet port 111 to help to close and to help to regulate flow of fluids, semi-solids and/or solids from the inlet conduit 113 through the inlet port 111 into the food-zone passage 106. The inlet conduit 113, the inlet port 111 and the valve or regulator 111A may be configured to deliver exclusively pressurized gas, e.g., air, into the food-zone passage 106. In this case, the cooling chamber 102 may include the inlet conduit 110 and inlet port 108 to deliver a product mix or product mix ingredients into the food passage 106, while the inlet conduit 113 and inlet port 111 to supply pressurized gas, e.g., air, into the food passage.

The assembly 100 may include either port 110 and 111 with a valve or flow regulator 108A and 111A that receives and delivers a previously aerated product mix, product base mix with or without flavorings, and/or other aerated product ingredients from the turbulence tube assembly shown in FIG. 6, the mixing tube shown in FIG. 6A, or other aeration system or method.

The assembly 100 also includes an end plate 112 that is constructed and arranged to open an end of the food-zone passage 106 and a bulkhead plate 114 to seal an opposite end of the food-zone passage 106.

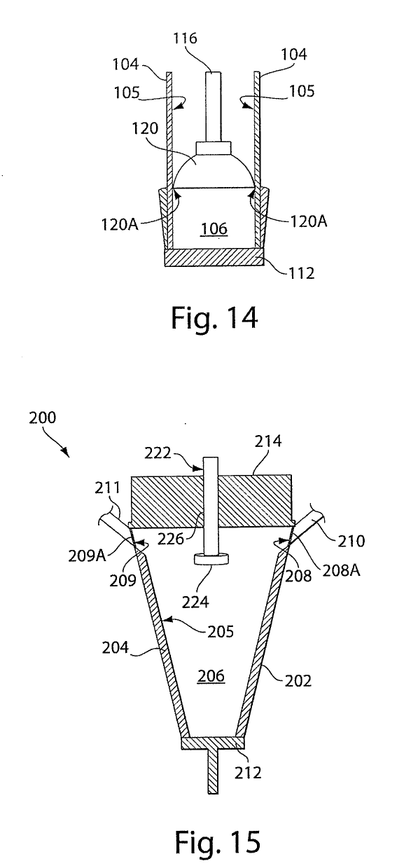

With further reference to FIGS. 11-14, a pushing/scraping tool 117 including a shaft 118 extends through the bulkhead plate 114 into the food-zone passage 106 to at least an opposite end of the food-zone passage 106 and proximate to or adjacent the end plate 112, as shown in FIG. 14. The shaft 118 may extend from the bulkhead plate 114 substantially along the center or central axis of the food-zone passage 106, or, alternatively, offset from the center or central axis of the food-zone passage 106. A shaping cavity 120 mounts to an end of the shaft 118. The shaping cavity 120 is disposed such that where the shaft 118 is extended into the food-zone passage 106 proximate to or adjacent the end plate 112, and the end plate 112 is unlocked and removed wholly or partially from the cooling chamber 102, the shaping cavity 120 is substantially proximate to an opening or passage (not shown) that is exposed upon the full or partial removal of the end plate 112. The shaping cavity 120 and the shaft 118 may further extend into the food-zone passage 106, if needed, to push or to dispense otherwise a food product from the food-zone passage 106, as described below.

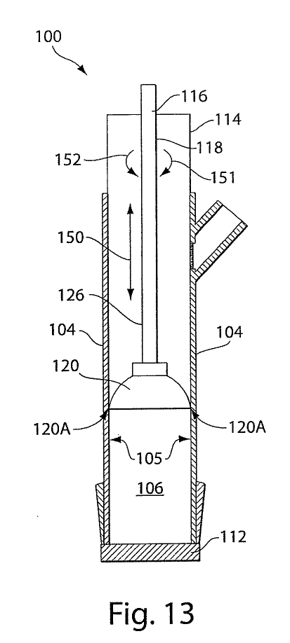

In one embodiment, the shaft 118 may mount through an orifice in the bulkhead plate 114. More specifically, the shaft 118 may be threaded and mounted through an inversely threaded orifice (not shown) defined in the bulkhead plate 114. The threads on the shaft 118 may extend only around a portion of the diameter of the shaft 118 and the inverse threads of the orifice of the bulkhead plate 114 may be displaced so that the shaft 118 may be uncoupled from its mount within the threaded orifice such that the shaft 118 may be displaced axially along at least a portion of the length of the food-zone passage 106 in a downward orientation and/or in an upward orientation, as shown by arrow 150 in FIG. 13. In addition, the shaft 118 may be adapted to enable the shaft 118 to rotate in a clockwise or a counterclockwise direction, as shown by arrows 151 and 152, respectively, in FIG. 13, either as the shaft 118 displaces axially within the passage 106 or if the shaft 118 is stationary.

The invention is not limited in this respect and envisions other configurations and/or arrangements for mounting, connecting or otherwise coupling the shaft 118 with the bulkhead plate 114, the cooling chamber 102, and/or with the food chamber assembly 100 to help to mount the shaft 118 such that the shaft 118 may be deployed within the food-zone passage 106 and may be displaced axially along at least a portion of the length of the food-zone passage 106 in an upward orientation and/or a downward orientation as described and as shown by arrow 150 in FIG. 13, with or without the ability to rotate as described and as shown by arrows 151 and 152 in FIG. 13.

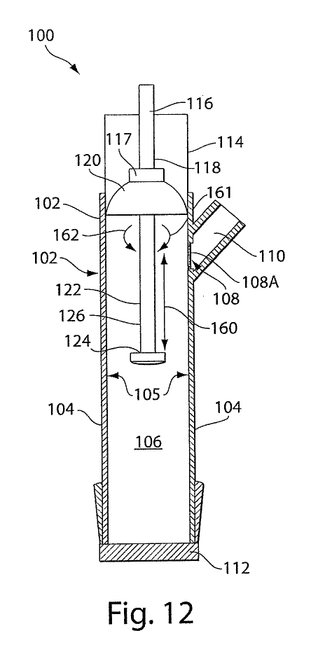

With reference to FIG. 12, the shaft 118 may further incorporate a product mix or product mix ingredients applicator 122 mounted to or integral with the shaft 118 and/or mounted to the bulkhead plate 114, e.g., with the orifice of the bulkhead plate 114, so that the product mix applicator 122 may be independently disposed within the food-zone passage 106 and may be independently displaced axially along at least a portion of the length of the food-zone passage 106 in a downward orientation and/or in an upward orientation, as shown by arrow 160 in FIG. 12. The applicator 122 includes a shaft 126 that may extend from the bulkhead plate 114 substantially along the center or central axis of the food-zone passage 106, or, alternatively, offset from the center or central axis of the food-zone passage 106. Alternatively, or additionally, the shaft 126 of the applicator 122 may be adapted to rotate in a clockwise or a counterclockwise direction during deployment of the applicator 122 into the food-zone passage 106 in a downward and/or an upward orientation as described, or while the applicator 122 is stationary.

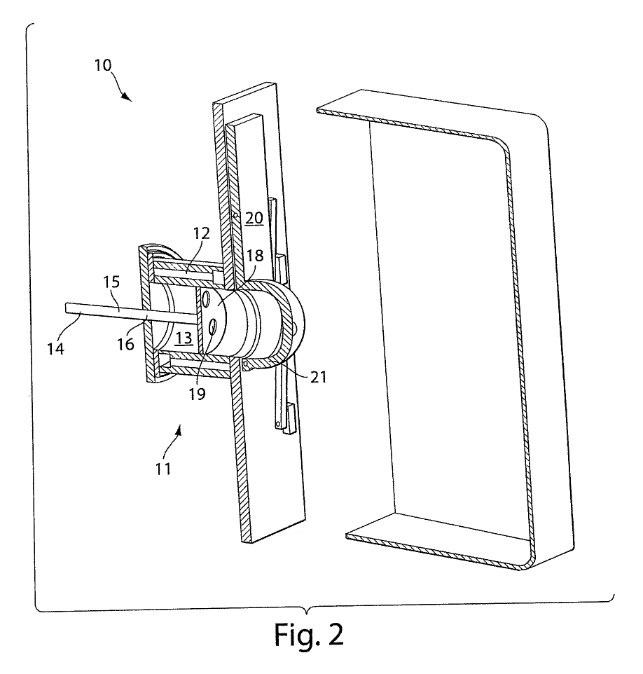

In one embodiment, as shown in FIG. 12, the shaft 118 may incorporate the shaft 126 of the product mix applicator 122 such that the shaft 118 telescopically receives the shaft 126 of the applicator 122. The shaft 126 may mount to the bulkhead plate 114, to the orifice of the bulkhead plate 114, and/or to the shaft 118 such that the shaft 126 may displace axially along at least a portion of the length of the food-zone passage 106, as shown in FIG. 2. More specifically, in one embodiment, the shaft 126 of the applicator 122 may include threads that permit it to mount to an inversely threaded section of the bulkhead plate 114, the orifice of the bulkhead plate 114, and/or the shaft 118. The threads of the shaft 124 may extend only around a portion of the diameter of the shaft 126 and the inverse threads of the bulkhead plate 114, the orifice of the bulkhead plate 114, and/or the shaft 118 may be displaced so that the shaft 126 may be uncoupled from its mount in the bulkhead plate 114, the orifice of the bulkhead plate 114, and/or the shaft 118 to permit the shaft 124 to be displaced axially along at least a portion of the length of the food-zone passage 106 to thereby extend and retract the shaft 126 in a downward orientation and/or in an upward orientation within the food-zone passage 106, as shown by arrow 160 in FIG. 2. The shaft 126 may be adapted to rotate in a clockwise or a counterclockwise direction, as shown by arrows 161 and 162, respectively, in FIG. 12, while the shaft 126 deploys into the passage 106 or while the shaft 126 and/or the shaft 118 are stationary and/or while the scraper shaft 118 is stationary.

Alternatively, in another embodiment, the applicator 122 and its shaft 126 may be mounted to, integral with or otherwise connected to the bulkhead plate 114 and/or to the cooling chamber 102 independently and separate from the shaft 118 of the pushing/scraping tool 117 such that the applicator 122 may be deployed, extended and rotated as described above. In this case, the pushing/scraping tool 117 may not deploy within the food-zone passage 106, while the applicator 122 deploys within the food-zone passage 106.

The invention is not limited in this respect and anticipates other configurations and/or arrangements for mounting, connecting or otherwise coupling the shaft 118 with the bulkhead plate 114, the cooling chamber 102, and/or with the food chamber assembly 100 to help to mount, integrate or otherwise connect the shaft 126 to the bulkhead plate 114 and/or to the cooling chamber 102 so that the applicator 122 may be deployed into the passage 106 and extended axially in a downward or an upward orientation, as described and shown by arrow 160 in FIG. 12, with or without the shaft 126 having the ability to rotate, as described and shown by arrows 161 and 162 in FIG. 12.

The food-zone passage 106 is sealed at both ends, e.g., by the end plate 112 and the bulkhead plate 114, and as mentioned may be pressurized with pressurized gas, e.g., compressed air. The invention in not limited in this respect and envisions the cooling chamber 102 may be sealed by other configurations and/or devices to help to seal the food-zone passage 106.

Temperature of the inner surface 105 of the wall 104 is controlled in order at least a portion of the inner surface 105 cools or at least partially freezes a product mix or product mix ingredients via thin film cooling or freezing. In one embodiment, temperature for the wall 105 and the inner surface 105 is controlled a configurable amount through circulation of one or more chilled liquids or coolants through the wall 104. In one embodiment, the wall 104 of the cooling chamber 102 is hollowed to create a pathway for circulation of one or more liquids or coolants through the wall 104 in order that at least a portion of the inner surface 105 of the wall 104 is cooled or chilled and is maintained at any temperature(s) of a range of temperatures sufficient to cool and/or to wholly or partially freeze a product mix when the product mix, e.g., a liquid product mix, a chilled liquid product mix, a partially-frozen product mix, aerated or non-aerated product mix and/or ingredients thereof, are applied to at least a portion of the inner surface 105. The wall 104 may include within its interior one or more dividers 103, e.g., one or more dividers 22 as shown in FIGS. 4 and 5, such that the inner structure of the wall 104 may define sections and may create a tortuous pathway for the coolant through the wall 104. The coolant may comprise a chilled fluid, e.g., supplied to the assembly 200 by a chiller system operatively coupled with the assembly 200, or a refrigerant, such as a chlorofluorocarbon, e.g., supplied to the assembly 200 by a refrigeration system operatively coupled with the assembly 200, or a eutectic cooling composition, that help to maintain the inner surface 205 at relatively consistent temperatures within a range of temperatures that are required or desired to produce one or more food products.

With further reference to FIG. 12, as mentioned, the applicator 122 is adapted so that the applicator 122 may displace independently axially along at least a portion of the length of the food-zone passage 106 in a downward orientation and/or in an upward orientation, as shown by arrow 160 in FIG. 12. In addition, the applicator 122 is adapted, e.g., includes the shaft 126 configured as a hollowed shaft, to help to deliver the product mix and/or product mix ingredients to the applicator 122 and to further deliver the product mix and/or product mix ingredients to an applicator head 124 that is connected to the applicator 122. The applicator head 124 is constructed and arranged to help to deliver the product mix and/or product mix ingredients to the passage 106 and to help to apply the product mix to at least a portion of the inner surface 105 of the refrigerated wall 104 for thin film cooling or at least partially freezing. The invention envisions any of a variety of configurations of the applicator head 224 to introduce and to help to apply a product mix and/or product mix ingredients to at least a portion of the inner surface 205.

In one embodiment, the applicator head 124 may be adapted as a product mix and/or product mix ingredients spray nozzle 124 that defines a plurality of apertures (not shown) through which the mix and/or ingredients are supplied to the passage 106 and are applied to the inner surface 205. In this case, the interior of the shaft 126 may be hollowed and/or may include one or more channels, to deliver the product mix or ingredients to the nozzle 124. The interior of the shaft 226 may be pressurized, e.g., at about 40 psi, before and/or after delivery of the product mix and/or ingredients to the nozzle 124 to facilitate dispensing the mix and/or ingredients through the apertures of the nozzle 124 and applying the product mix to the inner surface 105 of the wall 104. Alternatively, the product mix and/or ingredients may be delivered to the nozzle 124 under pressure, e.g., at about 40 psi, such that the pressurized product mix and/or ingredients are dispensed through the apertures of the nozzle 124 and are projected therefrom along the inner surface 105. As another alternative, the nozzle 124 may receive the product mix and/or ingredients without pressurization of the product mix and/or ingredients, or without pressurization of the interiors of the shaft 126 and the nozzle 124, wherein the product mix and/or ingredients flow through the apertures for application to the inner surface 105. The nozzle 124 may be held sufficiently close to and/or aligned with the inner surface 105 to help the nozzle 124 apply the product mix and/or ingredients to the surface 105. In all of the foregoing instances, the applicator shaft 126 may be rotated in a clockwise or a counterclockwise direction, as described above, with or without movement of the shaft 126 and the nozzle 124 in an upward and/or a downward orientation, as described above, to help to dispense the product mix from the nozzle 124 and to help to apply the product mix to the inner surface 105.

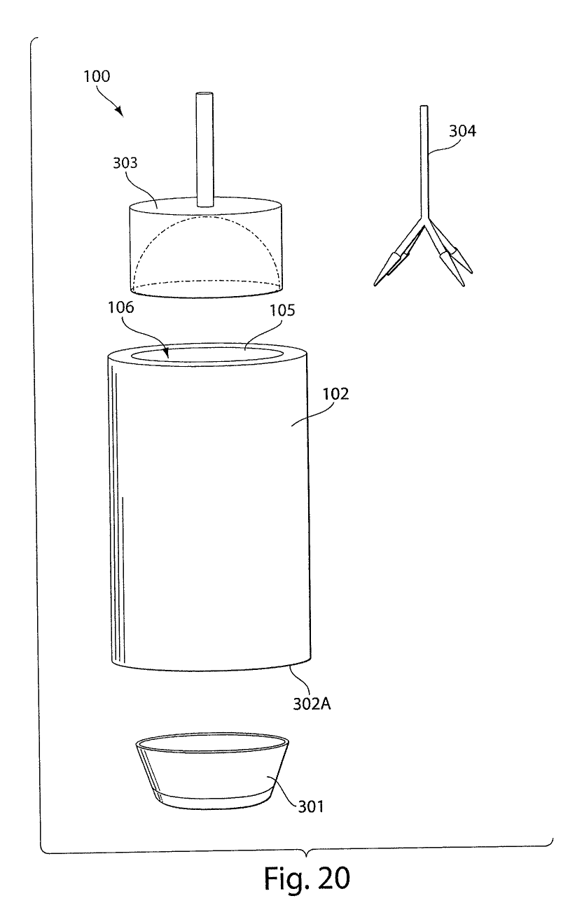

The invention is not limited to the product mix applicator 122 and spray nozzle 124 as shown and described with reference to FIG. 12 and envisions any of a variety of configurations of the applicator 122 and the applicator head and/or other devices adapted to apply one or more thin layers of product mix and/or product mix ingredients to at least a portion of the inner surface 105, as described below with reference to FIGS. 20-30.

Application of the product mix and/or the product mix ingredients having a predetermined and/or controlled volume or amount to at least a portion of the inner surface 105 of the wall 104 as described, deposits or applies the product mix and/or product mix ingredients as one or more thin layers. Each layer may have a desired or required thickness, e.g., from about 0.005 inches to about 0.1 inches, that cools or freezes, wholly or partially, along the inner surface 105. The degree to which the product mix and/or the product mix ingredients cool or freeze along the inner surface 105 is at least a function of the thickness of the one or more thin layers applied to the inner surface 105 such that a range of food product textures, consistencies and properties may be achieved, e.g., including a chilled liquid food product and/or a partially or wholly frozen food product, with the assembly 100. Upon completion of the deposition or application of a volume or amount of the product mix and/or ingredients to the inner surface 105, the shaft 126 and applicator head 124 retract, e.g., telescopically into the shaft 118 of the pushing/scraping tool 117, the bulkhead plate 114 and/or alternatively otherwise exits the food-zone passage 106.

The thickness of each of the one or more thin layers applied may depend upon the length of the inner surface 105 exposed within the food-zone passage 106. In addition, the thickness of each of the one or more thin layers applied may depend upon at least the temperatures at which the inner surface 105 is maintained and/or the length of time each of the one or more thin layers are allowed to remain on the inner surface 105. Further, the product mix and/or product mix ingredients may be applied with any of a range of thicknesses and may be maintained at any of certain temperatures for any of certain periods of time to achieve the required or desired consistency, texture and/or properties of a final food product.

With further reference to FIGS. 13 and 14, after one or more layers of product mix and/or product mix ingredients are applied to at least a portion of the inner surface 105 and maintained along the inner surface 105 for a certain period of time sufficient to cool or chill or to wholly or partially freeze the one or more layers, the pushing/scraping tool 117 is deployed into the food passage 106 as the shaft 118 extends axially into the food-zone passage 106 as described above. The shaping cavity 120 is disposed and is configured, e.g., defines a scoop shape or hemisphere with a circular cross-section and volume, such that an outer perimeter or circumferential edge 120A of the shaping cavity 120 contacts the one or more thin layers and/or contacts the inner surface 105. As the shaft 118 extends into the food-zone passage 106, the shaping cavity 120 scrapes or otherwise removes the one or more thin layers from the inner surface 105 and moves toward the end plate 112. As a result, the shaping cavity 120 captures within its volume the one or more thin layers removed from the inner surface 105 and shapes or forms the removed thin layer(s) into a required or desired shape, e.g., a rounded or scoop shape, as the cavity 120 fills with the removed thin layer(s) and moves toward the end plate 112. The shaping cavity 120 may further retain the formed or shaped food product within the cavity 120 until such time for dispensing the food product. For instance, the cavity 120 may retain the food product until the cavity 120 is proximate to or adjacent an opening or passage (not shown) the cooling chamber 102 may define and which the end plate 112 wholly or partially covers. Full or partial removal of the end plate 112 would expose the opening or passage to allow the shaping cavity 120 to locate the formed or shaped food product proximate to or adjacent the opening or passage for dispensing. Alternatively, or additionally, the shaping cavity 120 may locate the formed or shaped food product proximate to or adjacent the opening or passage to push the food product through the opening or passage so that the food product is ejected or otherwise dispensed from the food-zone passage 106. Optionally, one or more add-ins may be added, e.g., via the inlet conduit 110 and the inlet port 108, to the food passage 106 and thereby to the formed or shaped product, e.g., at periodic intervals during movement of the pushing/scraping tool 117 through the food-zone passage 106 or after the shaping cavity 120 has removed the one or more thin layers.

The food product may comprise a range of sizes/volumes from single serving volumes, e.g., of about 4 to about 7 oz., to comparatively larger masses or volumes of food product, e.g., of from about 16 oz. to about 32 oz. portions or larger, as noted above. The assembly 100 may produce single serving volumes or comparatively larger volumes of food product by producing sequential batches of the food product whereby a first volume of the product mix, e.g., aerated or non-aerated, is supplied to the food-zone passage 106 and applied to at least a portion of the inner surface 105 of the refrigerated wall 104. The applicator 122 extends axially into the food-zone passage 106 and moves in a downward and/or in an upward orientation as a single pass through the passage 106 or as multiple passes, e.g., up and down, through the passage 106, with or without rotating, to apply the first volume of product mix and/or product mix ingredients to at least a portion of the inner surface 105 as one or more thin layers. The shaping cavity 120 extends axially in a downward and/or an upward orientation as a single pass through the passage 106 or as multiple passes, e.g., up and down, through the passage 106, with or without rotating, to scrape or to otherwise remove the one or more thin layers from the inner surface 105. A first batch of the food product is produced and the shaping cavity 120 may dispense the first batch from the food-zone passage 106 into a container, as described above. Optionally, one or more add-ins may be added, e.g., via the inlet conduit 110 and the inlet port 108, to the first batch of product, e.g., at periodic intervals during movement of the shaping cavity 120 through the food-zone passage 106 or after the shaping cavity 120 has removed the first batch product from the inner surface 105, to layer or to otherwise incorporate the add-ins into the first batch of product. A second and additional volumes of the product mix and/or product mix ingredients, e.g., aerated or non-aerated, may be subsequently and sequentially added to the food-zone passage 106 to produce a second and additional batches of food product until the required or desired volume of food product is achieved and is dispensed into the container. Optionally, as described, one or more add-ins may be added, e.g., via the inlet conduit 110 and the inlet port 108, to the second and additional batches of food product, e.g., at periodic intervals during movement of the shaping cavity 120 through the food-zone passage 106 or after the shaping cavity 120 has removed the second batch and each additional batch from the inner surface 105, to layer or to otherwise incorporate the add-ins into the second and additional batches of product.

For comparatively larger volumes of food product, the thin layer tubular cooling chamber assembly 100 is a packer tubular cooling chamber assembly 100, as similarly described above with respect to FIGS. 1-10, wherein the cooling chamber 102, the food-zone passage 106, the applicator 122, and/or the scraper and the shaping cavity 120 are to handle larger first, second and additional volumes of product mix to produce, e.g., in the batch mode as described above or in a single batch, pint and quart-size and/or larger volumes of food product. The shaft 118 and the shaping cavity 120 may be adapted to extend from and to exit the packer food-zone passage 106 and at least a portion of the shaping cavity 120 may be received by at least a portion of the container into which the food product is dispensed so that the shaping cavity 120 may push down or otherwise pack the food product into the container.

In another embodiment, the shaft 118 of the shaping cavity 120 may include one or more channels (not shown) for delivery of pressurized gas to the shaping cavity 120 to help to eject or otherwise dispense the formed/shaped product mix from the shaping cavity 120 and through the opening or passageway the end plate 112 protects. In this instance, a pressurized gas supply operatively coupled with the assembly 100 may supply the pressurized gas. In addition, in a further embodiment, the shaping cavity 120 may include an elastic, displaceable diaphragm (not shown) that may extend across the perimeter or circumference 120A of the rounded cavity 120 to help to eject or to otherwise dispense the formed/shaped product mix from the shaping cavity 120. The diaphragm, when not deployed, is disposed along or lines at least a portion of the inner surface of the shaping cavity 120. When pressurized gas is supply to the hollow shaft 118, the pressurized gas is fed to the shaping cavity 120 via an outlet port (not shown) defined in the shaping cavity 120 that places the inner surface of the shaping cavity 120 and the interior of the hollow shaft 116 in fluid communication. As the pressurized gas passes through the outlet port, the pressurized gas flow along the inner surface of the shaping cavity 120, which causes the diaphragm to deploy or to extend across the perimeter or circumference 120A of the shaping cavity 120. Deployment of the diaphragm causes the formed/shaped product to eject or otherwise dispense from the shaping cavity 120. Thereafter, the formed/shaped product mix exits the food-zone passage 106 through the opening or passage that the end plate 112 protects and dispenses into a container. The container is positioned in an area external to the food-zone passage 106 and is accessible to an end-user in order for the end-user to retrieve the container holding the dispensed product.

The chamber 102 is constructed or one more materials suitable to help to maintain the shape and configuration of the chamber 102 under applications of high gas pressure, e.g., during introduction of pressurized gas into the chamber 102 during pressurization of the food passage 106 and/or cleaning of the food passage 106. The chamber 102 may further include an external insulating jacket substantially surrounding an exterior of the chamber 102 and constructed of one or more materials suitable to help to prevent or at least minimize thermal exchange between the food passage 106, the wall 104 and an area external to the chamber 102.

Other embodiments of the assembly 100 described above with reference to FIGS. 11-14 are within the scope and spirit of the invention. For example, the inner surface 105 of the refrigerated wall 104 may be constructed of or coated with a material, or otherwise treated, to help to promote non-stick application of the product mix and/or product mix ingredients to the inner surface 105 to thereby help to facilitate removal of the one or more thin layers formed therefrom along the inner surface 105, such as that disclosed in U.S. Pat. No. 6,745,595. In addition, the inner surface may be constructed of or coated with a material, or otherwise treated, to help to promote freezing of the product mix to form the food product. The assembly 100 may include a separate applicator, e.g., similar to the applicator 122 described above, to apply one or more substances to the inner surface 105 to achieve a coating or treatment to help to facilitate freezing. Alternatively, an applicator may be used to apply the one or more substances for treatment of the inner wall 105 to help to facilitate removal of the one or more thin layers and/or to help to facilitate freezing. Such applicator may be deployed into the food passage 106 through the bulkhead plate 114, or, alternatively, through an inlet port defined in the chamber wall 104. The specification below describes, and FIGS. 20-32 illustrate, other potential applicators.

As another example, the shaft 118 may be adapted to receive telescopically the shaft 126 of the product mix applicator 122, as mentioned above, and may be adapted to integrate the shaft 126 such that the shafts 118 and 126 define a universal telescoping shaft 116 that enters the bulkhead plate 114 at a single point of entry. Another example includes introduction of pressurized gas, e.g., compressed air, and/or a cleaning fluid supplied into the food-zone passage 106 to clean and to otherwise remove any residual product mix, product mix ingredients and/or one or more thin layers from the inner surface 105, the shafts 118 and 122, the applicator head 124, along an inner surface of the end plate 212, and/or any other areas/surfaces within the passage 106 that are potentially exposed to the product mix and ingredients. The inlet conduit 110 and inlet port 108, the inlet conduit 113 and inlet port 111, and/or the applicator 122 may introduce pressurized gas and/or cleaning fluid into the food passage 106 for cleaning purposes.

As another example, where the chamber 102 is dedicated to the specialized task of mixing the product mix ingredients to form a product mix and/or aerating the formed product mix, the inner wall 105 of the chamber 102 may define one or more notches, orifices or other raised portions of its surface to help to increase an amount of agitation of the product mix or ingredients.

Another example includes the refrigerated wall 104 operatively connected to a refrigeration system associated with the automated machine described in U.S. 2006/0054614 A1 to enable temperature control of the wall 104 and inner surface 105. Alternatively, temperature control of the refrigerated wall 104 and the inner surface may be achieved with chemical refrigeration or thermo-electric devices and methods.

Referring to FIGS. 15-19, in another aspect the invention is provides a modified cooling chamber assembly 100, shown and described with reference to FIGS. 11-14, that includes a funnel cooling chamber assembly 200 for preparing a frozen, a partially frozen or chilled liquid beverage. The funnel cooling chamber assembly 200 can substitute the food-preparation assembly 22 described in the apparatus of U.S. Application Publication No. 2006/0054614 A1 noted above. The funnel cooling chamber assembly 200 includes a funnel-shaped cooling chamber 202 with a refrigerated wall 204 that encloses a beverage-zone passage 206. The beverage-zone passage 206 may define a funnel-shaped inner surface 205 of the refrigerated wall 204. As shown in FIGS. 15-19, the inner surface 205 is disposed at an angle along the length of the beverage-zone passage 206 to define the passage 206 with a funnel shape. The inner surface 205 angles inwardly from about the top of the beverage-zone passage 206 as it extends to about an end plate 212 of the chamber 202. In one instance, for example, the inner surface 205 is angled at about 45 degrees from about the top of the beverage-zone passage 206, extending inwardly toward the end plate 212.

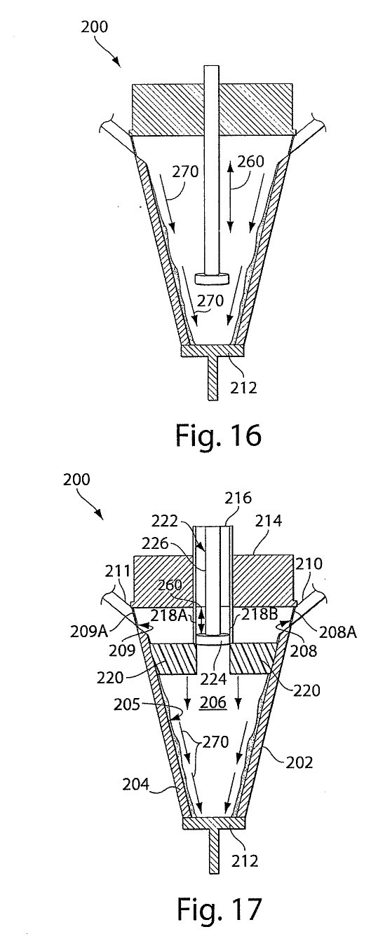

The funnel cooling chamber assembly 200 further includes a beverage mix applicator 222 having a shaft 226 and a beverage mix applicator head 224. The applicator 222 may mount to and/or may be integral with a bulkhead plate 214 that seals an end of the chamber 202 such that the applicator 222 may deploy within the beverage-zone passage 206 and may displace axially within the beverage-zone passage 206. More specifically, the shaft 226 of the applicator 222 may deploy within the passage 206 by displacing the shaft 226 axially along at least a portion of the length of the passage 206 such that the shaft 226 moves in a downward orientation and/or in an upward orientation, as shown by arrow 260 in FIG. 16. In one instance, for example, the shaft 226 may be further adapted such that the shaft 226 rotates in a clockwise and/or a counter-clockwise direction while being deployed in the passage 206 and, optionally, while moving in a downward orientation and/or in an upward orientation. Further, the shaft 226 may deploy into the passage 206 and extend from the bulkhead plate 214 substantially along the center or central axis of the passage 206, or, alternatively, offset from the center or central axis of the passage 206.

The shaft 226 may mount to the bulkhead plate 214 or may mount through an orifice of the bulkhead plate 214. More specifically, the shaft 226 may be threaded and mounted with an inversely threaded portion of the bulkhead plate 214 or mounted through an inversely threaded orifice (not shown) of the bulkhead plate 214. The threads on the shaft 226 may extend only around a portion of the diameter of the shaft 226 and the inverse threads of the portion of the bulkhead plate 214 or of the orifice may be displaced so that the shaft 226 may be uncoupled from its mount with the portion of the bulkhead plate 214 or its mount within the orifice such that the shaft 226 may be displaced axially along at least a portion of the length of the passage 206 in a downward orientation and/or in an upward orientation, as shown by arrow 260 in FIG. 16, with or without the shaft 226 rotating in a clockwise and/or counter-clockwise direction. The invention is not limited in this respect and envisions that other configurations and/or arrangements to mount or to otherwise connect the applicator 222 and its shaft 226 to the chamber 202 that would permit the applicator 222 and its shaft 226 to be disposed within the passage 206 and to be deployed axially as described, with or without the ability to rotate, are possible.

The assembly 200 may further include an inlet port 208 defined in the wall 204 and connected to an inlet conduit 210 whereby the interior of the inlet conduit 210 and the passage 206 are in fluid communication. A valve or a flow regulator 208A may couple with the inlet port 208 to help to close and to help to regulate flow of fluid or solids from the inlet conduct 210 through the inlet port 208 into the passage 206. The assembly 200 may optionally include a second inlet port 209 defined in the wall 204 and connected to a second inlet conduit 211 with a valve or a flow regulator 209A coupled to the inlet port 209. The second inlet port 209 and conduit 211 and the valve and flow regulator 209A may be similar to the other inlet port 208, conduit 210 and the valve and flow regulator 208A. Each of the inlet conduits and ports 208, 210 and 209, 211 may be adapted to deliver pressurized gas, e.g., compressed air, and/or to deliver a cleaning fluid to the passage 206. In addition, one or both of the inlet conduits and ports 208, 210 and 209, 211 may be employed to deliver beverage ingredients to the beverage-zone passage 206 to formulate such ingredients into a frozen or a partially frozen beverage.

Beverage ingredients may be provided as a beverage mix and may include, but is not limited to, a base mix, a chilled base mix or a partially frozen base mix, each optionally mixed with at least one flavoring and/or with one or more add-ins and further optionally aerated with pressurized gas, e.g., compressed air. Add-ins may include food products, e.g., fruit sections or bits, fruit-flavored condiments and/or sundries.

The refrigerated wall 204 of the cooling chamber 202 is hollowed to create a pathway for circulation of a coolant through the wall 204 in order that at least a portion of the inner surface 205 of the wall 204 is chilled and is maintained at a temperature sufficient to wholly or partially freeze the beverage ingredients introduced to the passage 206 and applied to the inner surface 205, as described below. The coolant may comprise a chilled fluid, e.g., supplied to the assembly 200 by a chiller system operatively coupled with the assembly 200, or a refrigerant, such as a chlorofluorocarbon, e.g., supplied to the assembly 200 by a refrigeration system operatively coupled with the assembly 200, or a eutectic cooling composition, that helps to maintain the inner surface 205 at a relatively consistent required or desired temperature. The refrigerated wall 204 may include within its interior one or more dividers, e.g., one or more dividers as shown in FIGS. 4 and 5, such that the inner structure of the refrigerated wall 204 may define sections and may create a tortuous pathway for the coolant through the wall 204.

The applicator head 224 of the beverage mix applicator 222 is constructed and arranged to help to deliver a beverage mix into the passage 206 and to help to apply the beverage mix to at least a portion of the inner surface 205 of the refrigerated wall 204. The invention envisions any of a variety of configurations of the applicator head 224 to introduce and to help to apply a beverage mix to the inner surface 205.

In one embodiment, the applicator head 224 may be adapted as a beverage mix nozzle 224 that defines a plurality of apertures (not shown) through which a beverage mix is supplied to the passage 206 and is applied to at least a portion of the inner surface 205. In this case, the interior of the shaft 226 may be hollowed and/or may include one or more channels to deliver the beverage mix to the nozzle 224. The interior of the shaft 226 and/or the interior of the nozzle 224 may be pressurized, e.g., at about 40 psi, before and/or after delivery of the beverage mix to the nozzle 224 to facilitate dispensing the beverage mix through the apertures of the nozzle 224 and applying the beverage mix to the inner surface 205 of the wall 204. Alternatively, the beverage mix may be delivered to the nozzle 224 under pressure, e.g., at about 40 psi, such that the pressurized beverage mix dispenses through the apertures of the nozzle 224 and projects therefrom to the inner surface 205. As another alternative, the nozzle 224 may receive the beverage mix without pressurization of the beverage mix, or pressurization of the interiors of the shaft 226 and the nozzle 224, and the beverage mix flows through the apertures for application to the inner surface 205. The nozzle 224 may be held sufficiently close to and/or aligned with the inner surface 205 to help the inner surface 205 to receive the beverage mix flowing from the apertures. In all of the foregoing instances, the applicator shaft 226 may be rotated in a clockwise or a counterclockwise direction, with or without movement of the shaft 226 and the nozzle 224 in an upward and/or a downward orientation, to help to dispense the beverage mix from the nozzle 224 and to help to apply the beverage mix to the inner surface 205.

With further reference to FIGS. 15 and 16, once applied to the inner surface 205, the beverage mix flows downward, as shown by arrows 270 in FIG. 16, because of the angle of the inner surface 205. As the beverage mix flows downward across the inner surface 205 toward the end plate 212, the beverage mix begins to chill or at least partially freeze. Chilling or freezing may be a function of at least the resident time along the inner surface 205, the length of the passage 206, the temperature of the inner surface 205, the freeze characteristics of the beverage mix, the size of the serving of the beverage end-product and/or other factors that are related to the extent of chilling or freezing of the beverage mix that is required or desired to form a frozen, a partially frozen or a chilled beverage. The beverage mix accumulates along a bottom of the passage 206, e.g., an inner surface of the end plate 212, as at least a partially frozen beverage and may be dispensed from the passage 20 after the end plate 212 is wholly or partially removed to expose an opening or passage through which the beverage may be dispensed to a container. In one embodiment, the inner surface of the end plate 212 may be adapted to keep the inner surface of the end plate 212 at a temperature sufficient to maintain the beverage at a required or desired temperature. In this case, the end plate 212 may be configured similar to the refrigerated wall 204 to circulate a chilled fluid within its hollowed interior.

The beverage mix may ultimately form a beverage, after flowing along the chilled inner surface 205, that has any of a range of frozen textures, consistencies and properties including a partially frozen to a relatively fully frozen beverage, or a chilled beverage, including, but not limited to, chilled or at least partially frozen beverages, shakes, frappes and slushes. In addition, the beverage mix may be applied with any of a range of thicknesses and may be maintained at any of a range of temperatures for any of certain periods of time to achieve required or desired frozen textures and properties of the beverage end product. Further, the funnel cooling chamber assembly 200 may be used to produce a frozen food product, such as described above with reference to FIGS. 11-14, including forming/shaping ice cream, frozen yogurt and non-dairy frozen products.

Referring to FIGS. 17-19, the assembly 200 as described above with reference to FIGS. 15 and 16, may further include a squeegee including a shaft 218 and one or more wiper blades 220 to help to remove the beverage mix from the inner surface 205. As shown in FIG. 17, in one embodiment, the shaft 218 comprises a first 218A and a second 218B stem to which a wiper blade 220 is attached. The shaft 218 may extend from the bulkhead plate 214 substantially along a center or central axis of the passage 206. Each of the wiper blades 220 mounts to an end of one of the stems 218A and 218B.

In one embodiment, the shaft 218 and/or each of the stems 218A and 218B may mount to a portion of the bulkhead plate 214 or may mount through an orifice of the bulkhead plate 214. More specifically, the shaft 218 and/or each of the stems 218A and 218B may be threaded and mounted to an inversely threaded portion of the bulkhead plate 214 or mounted to an inversely threaded orifice of the bulkhead plate 214. The threads on the shaft 218 and/or the stems 218A and 218B may extend only around a portion of the diameter of the shaft 218 and/or the stems 218A and 218B and the inverse threads of the portion of the bulkhead plate 214 or the orifice may be displaced so that the shaft 218 and/or the stems 218A and 218B may be uncoupled from their mount along the portion of the bulkhead plate 214 or within the orifice. The shaft 218 and/or the stems 218A and 218B may displace axially along at least a portion of the length of the passage 206 in a downward or an upward orientation, as shown by arrows 280 in FIG. 19. Movement of the shaft 218 and/or the stems 218A and 218B may occur independently of the applicator 222. Further, the shaft 218 and/or the stems 218A and 218B may be adapted to rotate in a clockwise or a counterclockwise direction, with or without a downward or an upward movement of the shaft 218 and/or the stems 218A and 218B, to help to remove the beverage mix from the inner surface 205. Alternatively, the squeegee may include a single shaft 218 or stem 218A or 281B with a single wiper blade 220 attached thereto.

The invention is not limited in this respect and anticipates other configurations and/or arrangements for mounting or for otherwise connecting the shaft 218 and/or the stems 218A and 218B to the bulkhead plate 214, the cooling chamber 202, and/or with the food chamber assembly 200 to help to mount, integrate or otherwise connect the shaft 218 and/or the stems 218A and 218B to the bulkhead plate 214 and/or to the cooling chamber 202 so that the shaft 218 and/or the stems 218A and 218B may be deployed into the passage 206 and extended axially in a downward or an upward orientation, as described above, with or without the shaft 218 and/or the stems 218A and 218B with or without the ability to rotate during deployment

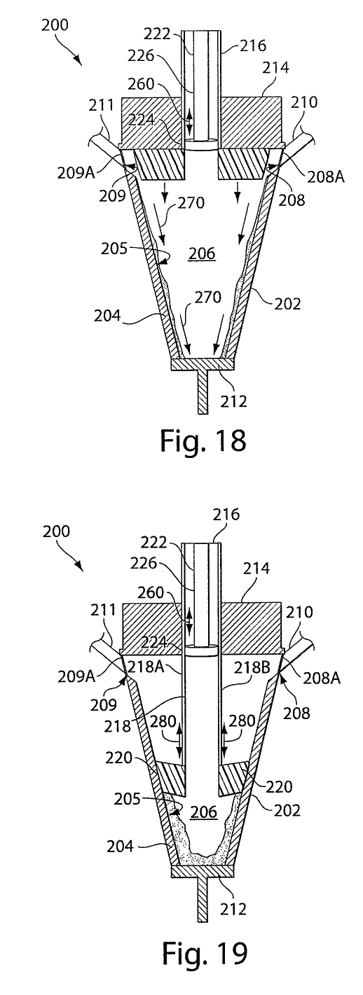

As shown in FIGS. 17 and 19, the shaft 218 and/or the stems 218A and 218B may be deployed into the passage 206 independently of and, optionally, simultaneously with the retraction of the applicator 222 from the passage 206. As the applicator 222 is retracting after application of the beverage mix to the inner surface 205, the shaft 218 and/or the stems 218A and 218B may be deployed axially into the passage 205 from a start position, as shown in FIG. 18, to a position wherein the wiper blades 220 contact or are flush with the inner surface 205. As the shaft 218 and/or the stems 218A and 218B move in a downward orientation toward the end plate 212, the wiper blades 220 remove the beverage mix from the inner surface 205 and force the beverage mix to flow toward the end plate 212 and, as mentioned above, to accumulate along a bottom of the passage 206, e.g., an inner surface of the end plate 212, as a chilled beverage or as at least a partially frozen beverage. The end plate 212 may be removed wholly or partially to dispense the chilled or at least partially frozen beverage from the passage 206.

As shown in FIGS. 17 and 19, in one embodiment, the shaft 218 and/or the stems 218A and 218B may incorporate the shaft 226 of the applicator 222 such that the shaft 218 and/or the stems 218A and 218B telescopically receive the shaft 226 of the applicator 222. In one embodiment, the shaft 218 and/or the stems 218A and 218B may be adapted to telescopically receive the shaft 226 and may be further adapted to integrate the shaft 226 such that the shaft 218 and/or stems 218A and 218B and the shaft 226 define a universal telescoping shaft 216 that enters the bulkhead plate 214 from a single point of entry. Alternatively, the shaft 218 and/or the stems 218A and 218B may be mounted independently of the applicator shaft 226 to the portion of the bulkhead plate 214 or the orifice of the bulkhead plate 214, e.g., as described above. Alternatively, shaft 226 may be mounted or otherwise connected to the bulkhead plate 214, the cooling chamber 202 and/or the assembly 200 independently and separate from the shaft 218 and/or the stems 218A and 218B

With further reference to FIGS. 17-19, the applicator 222 may be adapted such that the applicator 222 supplies pressurized gas, e.g., compressed air, and/or a cleaning fluid into the passage 206 to clean the passage 206 and to remove any beverage mix or residue thereof remaining within the food passage 206, along the inner surface 205, along the shaft 218, along the wiper blades 220 and/or from any other surfaces within the passage 206 that are potentially exposed to the beverage mix during its application. In one embodiment, the shaft 226 of the applicator 222 is hollow and includes one or more channels (not shown) into which a beverage mix may be introduced in order to supply the applicator head 224 with the beverage mix, as described above. Alternatively, or additionally, the one or more channels may also serve to deliver pressurized gas, e.g., compressed air, and/or a cleaning fluid into the applicator head 224 to supply gas and/or cleaning fluid to the passage 206 to clean and to remove beverage mix and residue as described.

With further reference to FIGS. 17-19, in one embodiment, the assembly 200 may exclude the beverage mix applicator 222 and include the squeegee with the shaft 218 and/or stems 218A and 218B and the wiper blades 220. In this case, one or both of the inlet ports and conduits 208, 210 and 209, 211 are employed to supply a beverage mix to the beverage-zone passage 206 and to supply the beverage mix along the inner surface 205 of the refrigerated wall 204. For instance, both of the inlet conduits 210 and 211 may be employed to supply beverage mix through the ports 208 and 209 to allow the beverage mix to apply to the inner surface 205 along opposite sides of the passage 205. The beverage mix is thereafter flows toward the end plate 212 and the squeegee is employed as described above. In this case, one or both of the inlet ports and conduits 208, 210 and 209, 211 may be further employed to supply pressurized gas, e.g., compressed air, and/or a cleaning fluid to the passage 206 to clean and to remove beverage mix and residue from the passage 206 and along the inner surface 205, along the shaft 218 and/or stems 218A and 218B, along the blades 220 and/or from any other surfaces within the passage 206 that are potentially exposed to the beverage mix during its application. The valve or flow regulators 208A and 209A of each port 208 and 209 may be employed to regulate flow of beverage mix, pressurized gas and/or cleaning fluid through the ports 208 and 209 and into the passage 206.

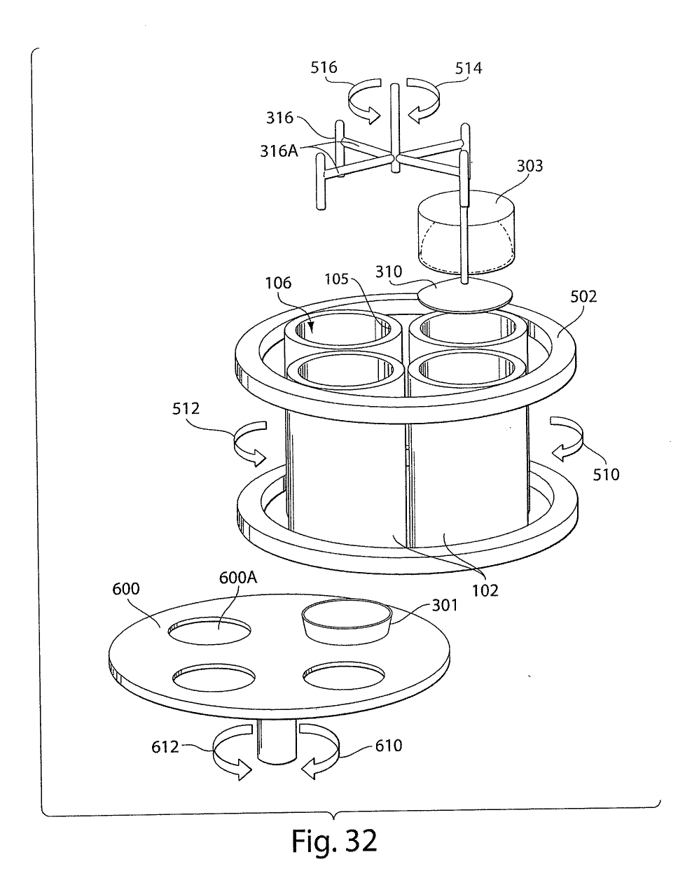

Referring to FIGS. 20-22, in another aspect the invention provides the cooling chamber 102 of the food zone assembly 100 substantially as shown in and described above with reference to FIGS. 11-14, with the chamber 102 constructed and arranged with or without the refrigerated wall 104 and including different pushing/scraping and applicator tools, as well as an alternative deployment of such tools within the food passage 106. As shown in FIG. 20, the chamber 102 aligns, e.g., vertically below, with one or more tools 303 and 304. The tools 303 and 304 may be constructed and arranged as a pushing/scraping tool and an applicator, respectively, and to align separately with the chamber 102 and, optionally, to align with a receptacle 301. In one arrangement either tool 303 and 304 aligns, e.g., vertically above, with the chamber 102 and with the receptacle 301 that aligns, e.g., vertically below, with the chamber 102. Alternatively, or additionally, the one or more tools 303 and 304 may integrate with a tool support structure 316 such as shown and described with reference to FIG. 32. The tools 303 and 304 are constructed and arranged to be extendible into the chamber 102 for permanent or temporary deployment within the chamber 102. One tool 303 or 304 may be temporarily deployed within the chamber 102 to perform a specific task and thereafter removed or replaced with another tool 303 or 304 to perform another task.

The tool support structure 316 is constructed and arranged to include tools 303 and 304, as well as additional tools 303 and 304 and/or different tools, as described below, including a spin coating tool 308, a reservoir coating tool 310 and/or a multi-tool head 312. Although the tool support structure 316 is not shown in FIGS. 20-22, one of ordinary skill can envision that the tool support structure 316 of FIG. 32 may align, e.g., vertically above, with the cooling chamber 102 such that at least one tool 303, 304, 308, 310 and 312 at any given time aligns, e.g., vertically above, with the chamber 102 and the food zone passage 106 and is thereby positioned for deployment into the food passage 106. In one embodiment, the tool support structure 316 is constructed and arranged as a rotating turret such that any one tool 303, 304, 308, 310 and 312 may be rotated, e.g., horizontally, to a position relative to the chamber 102 such that the tool 303, 304, 308, 310 or 312 aligns, e.g., vertically above, with the chamber 102 and the food passage 106 for deployment into the food passage 106. Alternatively, the tools 303, 304, 308, 310, and 312 may be deployed relative to and within the chamber 102 via a linear actuator or other transporting mechanism, such as a robotic arm. All or some of the tools 303, 304, 308, 310 and 312 are constructed and arranged to be extendible into the chamber 102.

The receptacle 301 may be positioned relative to, e.g., below, a base 302A of the cooling chamber 302 to accept and to help to form and/or collect a cooled or at least partially frozen aerated and/or non-aerated food product. The receptacle 301 may define any of a variety of shapes and sizes to accept and to contain a range of volumes or amounts of food product overrun. In some embodiments, multiple receptacles 301 may collect food product from the cooling chamber 302.

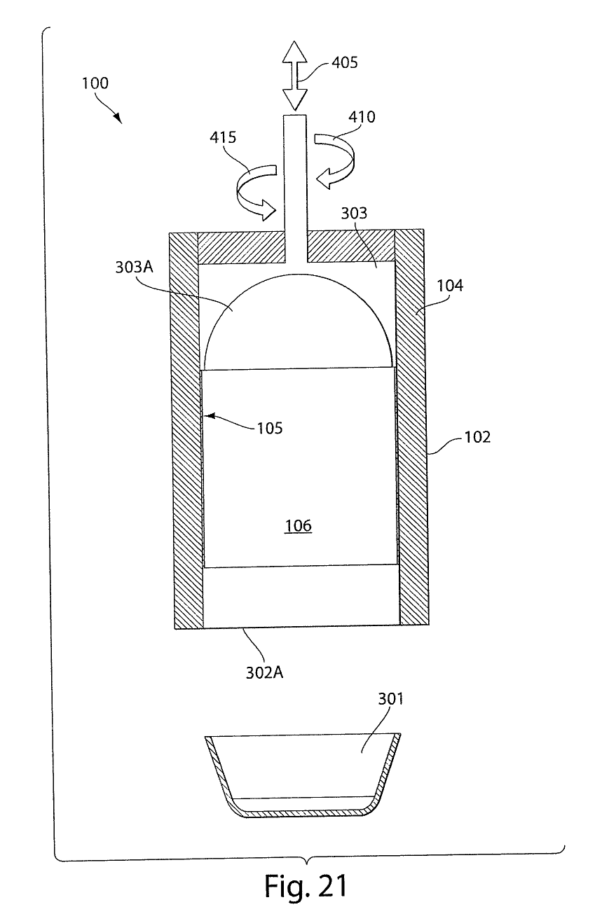

As shown in FIGS. 20 and 21, one of the multiple tools includes a pushing/scraping tool 303 constructed and arranged to align, e.g., vertically above, with the cooling chamber 302 to help to scrape the inner wall 105 and to clean the cooling chamber 302. More specifically, the pushing/scraping tool 303 is similar in application and function to the pushing/scraping tool 117 described with reference to FIGS. 11-14, although the pushing/scraping tool 303 of this embodiment may be removably deployed within the food passage 106 such that another tool may be subsequently deployed within the food passage 106. In addition, the pushing/scraping tool 303 is constructed and arranged to help to form a desired shape of the final food product and, optionally, to help to dispense the final food product from the food passage 106.

The pushing/scraping tool 303 is configured such that when deployed within the food passage 106 of the chamber 102, the tool 303 is disposed to contact the inner wall 105 and to help to scrape food product from at least a portion of the inner wall 105 and to move or push the removed food product through the chamber 102 and the base 302A of the chamber 102, e.g., via one or move opening/closing operative valves or orifices (not shown) the base 302A defines. The tool 303 may be further configured such that during or after scraping and pushing the food product through the chamber 102, the tool 303 helps to form the food product into a desired shape. As shown in FIG. 21, the tool 303 defines a concave scoop or hemisphere 303A that provides an interior volume, e.g., greater than that defined by the sides of the tool 303, to collect food product that the tool 303 scrapes or removes from the inner wall 105. The scoop or hemisphere 303A further helps to shape the removed food product into a final food product with a desired shape or configuration.

The cooling chamber 302 may subsequently align, e.g., vertically above, with the receptacle 301 during or after formation of the food product such that the tool 303 aligns, e.g., vertically above, with the receptacle 301 such that the tool 303 may push the removed food product through the one or more valves or orifices of the chamber base 302A into the receptacle 301.

In one embodiment, the pushing/scraping tool 303 may lower downward into the chamber 102 from a vertically aligned position above the chamber 102, as shown by arrow 405 in FIG. 21, thereby to deploy the tool 303 within the food passage 106. The tool 303 moves in a downward orientation, as shown by arrow 405 in FIG. 21, toward the chamber base 302A to remove the food product from the inner wall 105 and to push the food product through the food passage 106 toward the chamber base 302A. The tool 303 may be removed from the food passage 106 in an upward orientation, as shown by 405 in FIG. 21, to remove the tool 303 from the food passage 106 and, optionally, to return the tool 106 into the food passage 106 for a second or more passes to remove food product from at least a portion of the inner wall 105 and/or to clean at least a portion of the inner wall 105 by removing any residual food product. Alternatively, where the chamber 102 is disposed in a horizontal position relative to the vertical position shown in FIGS. 20 and 21, the pushing/scraping tool 303 may be deployed horizontally into the chamber 102 from a horizontally aligned position adjacent the chamber 102 to thereby deploy the tool 303 within the food passage 106.

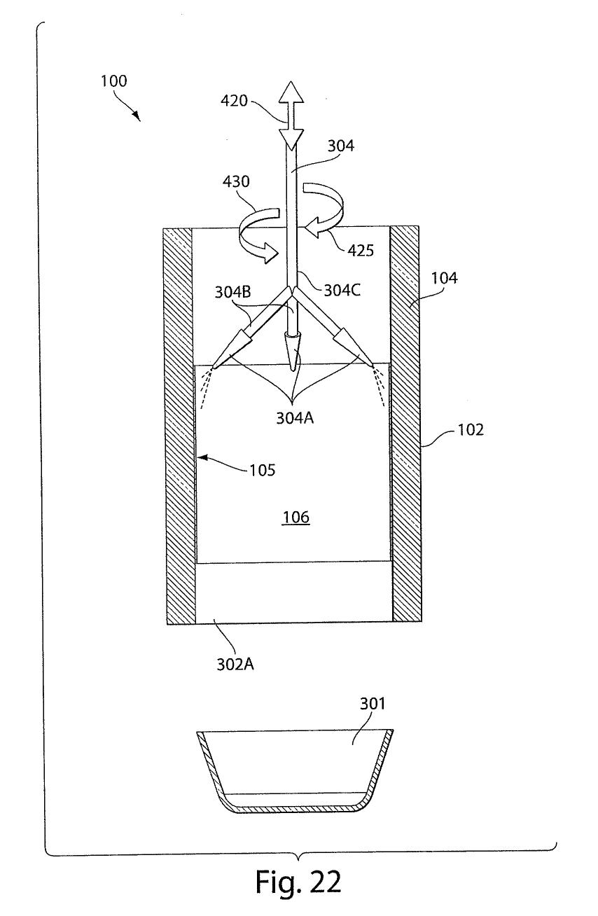

Alternatively, or additionally, the pushing/scraping tool 303 may rotate about an axis central to the tool 303 to aid in removing food product from the inner wall 105 of the chamber 102. As shown in FIG. 22, as the tool 303 travels through the food passage 106, e.g., vertically in a downward and/or upward orientation, the tool 303 may rotate or pivot about its central axis in a clockwise and/or counter-clockwise direction, as shown by arrows 410 and 415, respectively, in FIG. 22, to help to remove food product that lines at least a portion of the inner wall 105. The tool 303 may be configured to travel the entire vertical length of the food passage 106 or chamber 102, or at least a portion of the length of the food passage 106 or chamber 102. The tool 303 may be configured to actuate or to travel, e.g., vertically, along the length of the food passage 106 or chamber 102 one or more times before any other tool deploys into alignment with the chamber 102 or within the food passage 106.

As shown in FIG. 22, the chamber 102 may align, e.g., vertically below, with the applicator 304. The applicator 304 is constructed and arranged with a multiple of application heads 304A, e.g., spray nozzles, such that when the applicator 304 is deployed within the food passage 106 of the chamber 102, the applicator 304 is disposed and is configured to apply along at least a portion of the inner wall 105 a product mix and/or one or more product mix ingredients. As shown in FIGS. 20 and 21, the applicator 304 may be replaced subsequently with the pushing/scraping tool 303 after application of product mix or ingredients.

In one embodiment the applicator 304 is configured and designed as a spray coating tool 304 to apply or spray liquid product mix and/or liquid product mix ingredients as one or more layers to at least a portion of the inner wall 105 such that the product mix and/or ingredients may be cooled or at least partially frozen along the portion of the inner wall 105.

In one embodiment, the spray coating tool 304 may lower downward into the chamber 102 from a vertically aligned position above the chamber 102, as shown by arrow 420 in FIG. 22, to deploy the tool 304 within the food passage 106. The tool 304 moves in a downward orientation, as shown by arrow 420 in FIG. 22, toward the chamber base 302A to apply liquid product mix and/or ingredients to at least a portion of the inner wall 105. The spray coating tool 304 may disperse the liquid product mix and/or ingredients from one or more nozzle orifices 304A configured at the ends of branched extensions 304B of a main shaft 304C of the spray coating tool 304. A single product mix may be applied to at least a portion of the inner wall 105 using the spray coating tool 304, or alternatively, a product base mix and one or more flavorings may be dispensed simultaneously from the spray coating tool 304, with each of the product base mix and flavoring(s) dispensed from a single dedicated nozzle orifice 304A, or all of the product base mix and or flavoring(s) dispensed simultaneously from all of the nozzle orifices 304A.

The tool 304 moves in a downward orientation, as shown by arrow 420 in FIG. 22, toward the chamber base 302A to apply a product mix or product mix ingredients to at least a portion of the inner wall 105. The tool 304 may be removed from the food passage 106 in an upward orientation, as shown by 420 in FIG. 22, to remove the tool 304 from the food passage 106 and, optionally, to return the tool 304 into the food passage 106 for a second or more passes through the food passage 106 to apply additional product mix or ingredients to at least a portion of the inner wall 105. Alternatively, where the chamber 102 is disposed in a horizontal position relative to the vertical position shown in FIGS. 20 and 21, the tool 304 may be deployed horizontally into the chamber 102 from a horizontally aligned position adjacent the chamber 102 to thereby deploy the tool 303 within the food passage 106.

Alternatively, or additionally, the tool 304 may rotate about an axis central to the tool 304 to aid in applying product mix or ingredients along at least a portion of the inner wall 105 of the chamber 102. As shown in FIG. 22, as the tool 304 travels through the food passage 106, e.g., vertically in a downward orientation, the tool 304 may rotate or pivot about its central axis in a clockwise and/or counter-clockwise direction, as shown by arrows 425 and 410, respectively, in FIG. 22, to help to apply one or more layers of product mix or ingredients to at least a portion of the inner wall 105. The tool 304 may be configured to travel the entire vertical length of the food passage 106 or chamber 102, or at least a portion of the length of the food passage 106 or chamber 102. The tool 303 may be configured to actuate or to travel, e.g., vertically, along the length of the food passage 106 or chamber 102 one or more times before any other tool deploys into alignment with the chamber 102. In one embodiment, the tool 304 travels through the food passage 106 a number of times such that one or more layers of product mix or ingredients are applied, e.g., as one or more thin layers, to at least a portion of the inner wall 105 to form the food product via thin film cooling or freezing.

As described above, the chamber 102 may serve as a mixing chamber as well as a cooling chamber. In one embodiment, the chamber 102 serves serially as a mixing and a cooling chamber with the deployment of the applicator 304 and the pushing/scraping tool 303 by the tool support structure 316. In this case, the tool support structure 316 is configured and arranged to rotate, e.g., horizontally, such that either tool 303 and 304 aligns, e.g., vertically above, with the chamber 102 and the food passage 106, and may be further configured and arranged to deploy either tool 303 and 304 into the food passage 106. The applicator 304 may deploy initially to perform the task of applying product mix or ingredients to at least a portion of the inner wall 106 and the pushing/scraping tool 303 may deploy thereafter to perform the task of scraping food product from the inner wall 105 and pushing food product through the food passage 106.

Alternatively, or additionally, the chamber 102 may be configured and arranged to rotate, e.g., horizontally, such that the chamber 102 and the food passage 106 align, e.g., vertically below, with the tool support structure 316 generally and/or with either tool 303 and 304 specifically depending upon the next task to be performed in the chamber 102. In this case, the tool support structure 316 may remain stationary during rotation of the chamber 102.

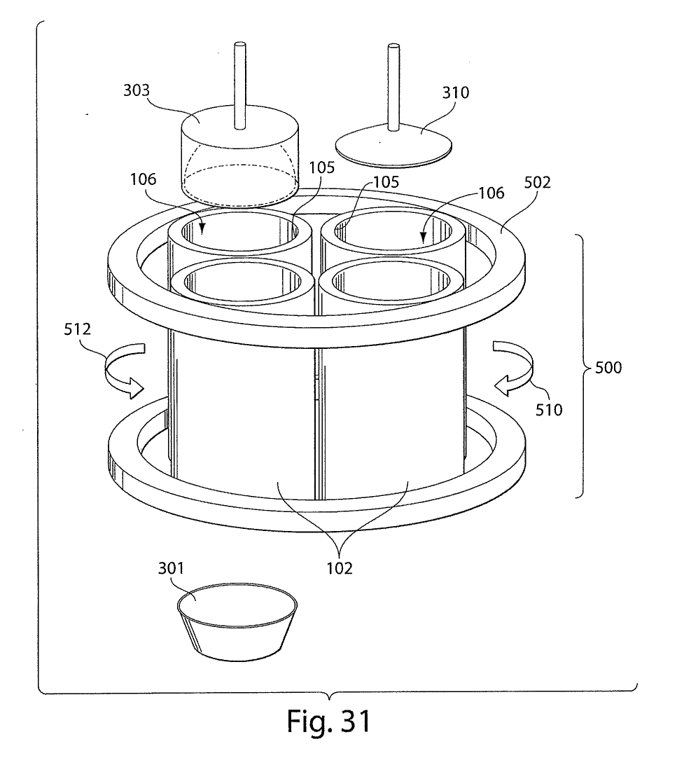

As described below in further detail with reference to FIGS. 31-33, one or more chambers 102 may be configured and arranged as a multiple of chambers 102, wherein the multiple of chambers 102 aligns, e.g., below, with the tool support structure 316 generally and the multiple of chambers 102 rotates, e.g., horizontally, such that one or more of the chambers 102 align, e.g., vertically below, with the structure 316 and/or a specific tool 303 and 304 that is required to perform the next task within the one or more chambers 102. In this case, the tool support structure 316 may remain stationary during rotation of the multiple of chambers 102 and thereafter during processing. Alternatively, or additionally, the structure 316 may rotate either before or after rotation of the multiple of chambers 102 to position the one or more tools 303 and 304 in the appropriate positions relative to the chamber 102 into which the tools 303 and 304 will be deployed.

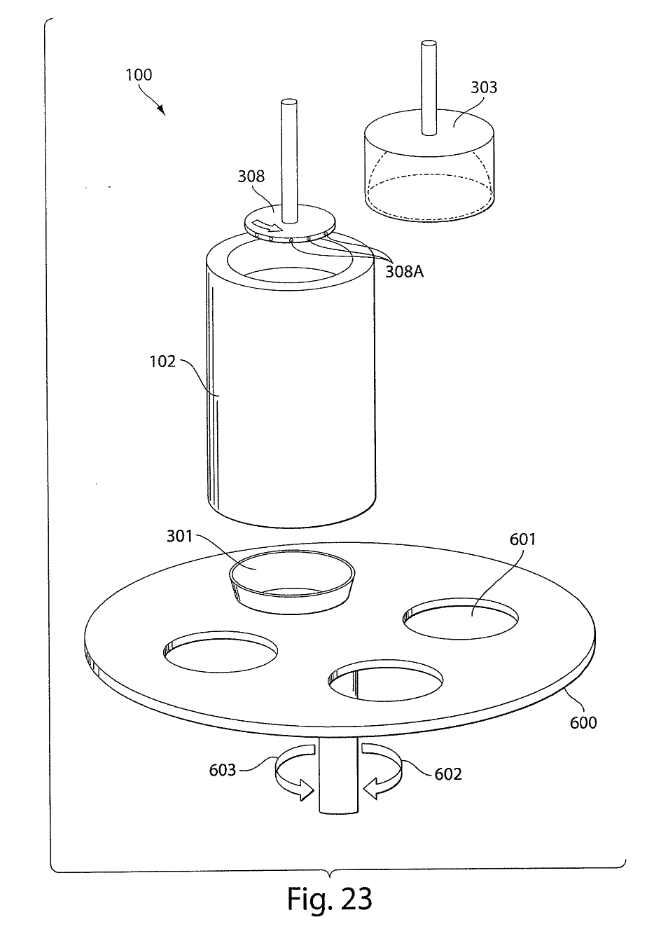

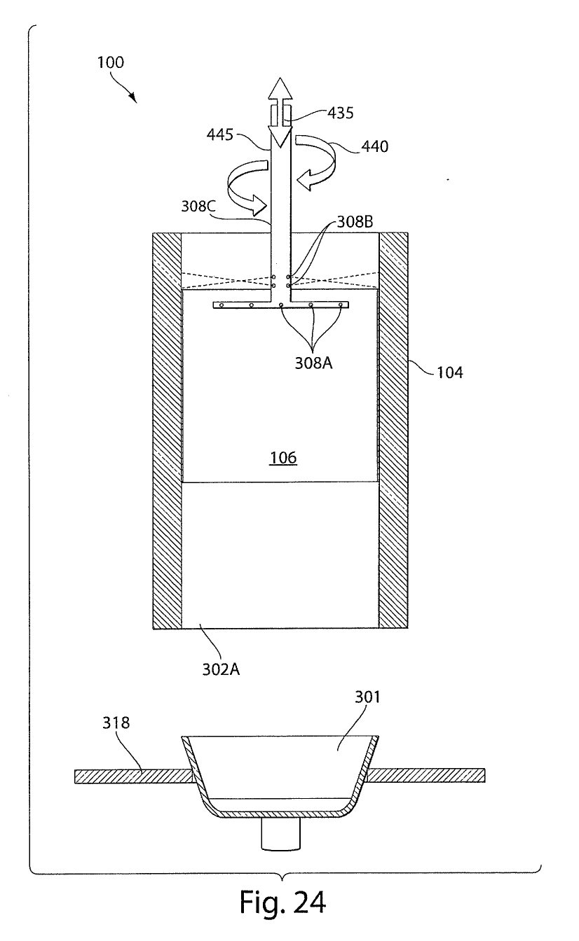

Referring to FIGS. 23 and 24, an additional tool includes a spin coating tool 308 that may deploy individually or as one of the set of tools 312 of the tool support structure shown in FIG. 32. The spin coating tool 308 is constructed and arranged to disperse or apply liquid product mix or liquid product mix ingredients along at least a portion of the inner wall 105. Alternatively, or additionally, the spin coating tool 308 may be constructed and arranged to apply one or more materials to at least a portion of the inner wall 105 including, but not limited to, one or more materials used to coat the inner wall 105 to help to facilitate cooling or at least partially freezing a product mix or ingredients applied to the inner wall 105, and/or to help to facilitate removal of the food product layer(s) formed along the inner wall 105, and/or to help to clean the inner wall 105 after food product formation and dispensing from the food passage 106.

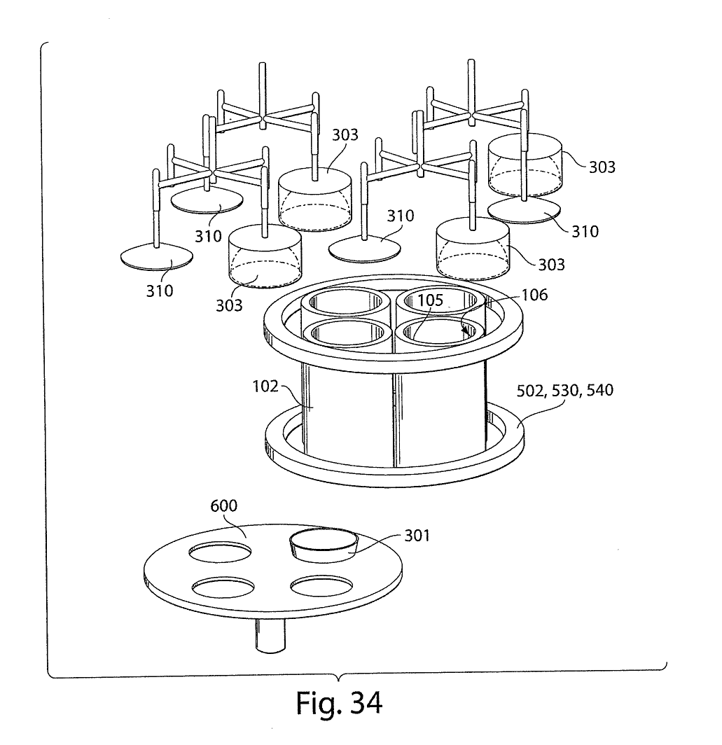

As shown in FIG. 23, the chamber 102 may align, e.g., vertically below, with the spin coating tool 308. The coating tool 308 is constructed and arranged to disperse liquid through a multiple of apertures 308A defined along its perimeter or side edge and/or through a multiple of apertures 308B defined along a shaft 308C of the tool 308. When the coating tool 308 deploys within the food passage 106 of the chamber 102, the coating tool 308 is disposed and configured to apply along at least a portion of the inner wall 105 a product mix and/or one or more product mix ingredients, and/or one or more coating materials such as those described above. As shown in FIGS. 23 and 34, the coating tool 308 may replace subsequently with the pushing/scraping tool 303 after application of product mix or ingredients.

In one embodiment the spin coating tool 308 is configured and designed as a spray coating tool to apply or spray liquid product mix and/or liquid product mix ingredients as one or more layers to at least a portion of the inner wall 105 such that the product mix and/or ingredients may be cooled or at least partially frozen along the portion of the inner wall 105. As mentioned, alternatively or additionally, the coating tool 308 may be used to apply one or more coating or cleaning materials along the inner surface 105

In one embodiment, the spin coating tool 308 may lower downward into the chamber 102 from a vertically aligned position above the chamber 102, as shown by arrow 435 in FIG. 24, to deploy the tool 304 within the food passage 106. The tool 308 moves in a downward orientation, as shown by arrow 435 in FIG. 24, toward the chamber base 302A to apply liquid product mix and/or ingredients to at least a portion of the inner wall 105 for food product formation. The tool 308 may disperse the liquid product mix and/or ingredients from the multiple of apertures 308A and/or 308B.

The tool 308 moves in a downward orientation, as shown by arrow 420 in FIG. 22, toward the chamber base 302A to apply a product mix or product mix ingredients to at least a portion of the inner wall 105. The tool 308 may be removed from the food passage 106 in an upward orientation, as shown by 435 in FIG. 22, to remove the tool 304 from the food passage 106 and, optionally, to return the tool 308 into the food passage 106 for a second or more passes through the food passage 106 to apply additional product mix or ingredients to at least a portion of the inner wall 105. Alternatively, where the chamber 102 is disposed in a horizontal position relative to the vertical position shown in FIGS. 23 and 23, the tool 308 may be deployed horizontally into the chamber 102 from a horizontally aligned position adjacent the chamber 102 to thereby deploy the tool 308 within the food passage 106.

Alternatively, or additionally, the tool 308 may rotate about an axis central to the tool 308 to aid in applying product mix or ingredients along at least a portion of the inner wall 105 of the chamber 102. As shown in FIG. 24, as the tool 308 travels through the food passage 106, e.g., vertically in a downward orientation, the tool 308 may rotate or pivot about its central axis in a clockwise and/or counter-clockwise direction, as shown by arrows 440 and 445, respectively, in FIG. 24, to help to apply one or more layers of product mix or ingredients to at least a portion of the inner wall 105. The tool 308 may be configured to travel the entire vertical length of the food passage 106 or chamber 102, or at least a portion of the length of the food passage 106 or chamber 102. The tool 308 may be configured to actuate or to travel, e.g., vertically, along the length of the food passage 106 or chamber 102 one or more times before any other tool deploys into alignment with the chamber 102. In one embodiment, the tool 308 travels through the food passage 106 a number of times such that one or more layers of product mix or ingredients are applied, e.g., as one or more thin layers, to at least a portion of the inner wall 105 to form the food product via thin film cooling or freezing.

In a similar manner, the spin coating tool 308 disperses within the food passage 106 and/or applies to at least a portion of the inner wall 105 one or more materials including one or more materials to help to facilitate cooling or at least partially freezing along the inner wall 105 and to help to facilitate removal of the food product from the inner wall 105. Also in a similar manner, the spin coating tool 308 disperses within the food passage 106 and/or applies to at least a portion of the inner wall 105 one or more cleaning materials to help to remove residual product mix or formed food product from the inner wall 105 and the food passage 106, as well as to clean other areas of the chamber 102.

With further reference to FIGS. 23 and 24, in some embodiments, a multiple of forming receptacles 301 are configured and disposed within a multi-receptacle support 600. The multi-receptacle support 600 is constructed and arranged such that one or more of the receptacles 301 align, e.g., vertically below, the chamber 102, as shown in FIG. 23. The support 600 is constructed and arranged, e.g., with one or more ports, to receive one or more receptacles 301. The supports 600 is also constructed and arranged to permit the multi-receptacle support 600 to rotate, e.g., horizontally, or to translate to help to align the support 600 and the one or more receptacles with the chamber 102 and, more particularly, with one or more valves or orifices along the bottom plate 302A of the chamber 102. In the embodiment shown in FIG. 23, the support 600 rotates horizontally in a clockwise and/or counter-clockwise direction, as shown by arrows 602 and 603, respectively, to deploy each receptacle 301 below the chamber 102 such that the receptacle 301 may receive a food product the chamber 102 dispenses and/or the pushing/scraping tool 303 pushes through one or more of the valves or orifices of the bottom plate 302A. The rotation of the support 600 may synchronize wholly or partially with the rotation of any of the tools 303, 304, 308, 310 and/or 312 and/or the rotation of the tool support structure 316 shown in FIG. 32.

In another embodiment, a multiple of forming receptacles 301 are configured and disposed along a linear actuator or conveyor mechanism, e.g., beneath the bottom plate 303A, that conveys the receptacles 301, e.g., in a horizontal orientation, to deploy one or more of the receptacles 301 below the chamber 102 to receive a food product through one or more of the valves or orifices (not shown) of the bottom plate 303A.

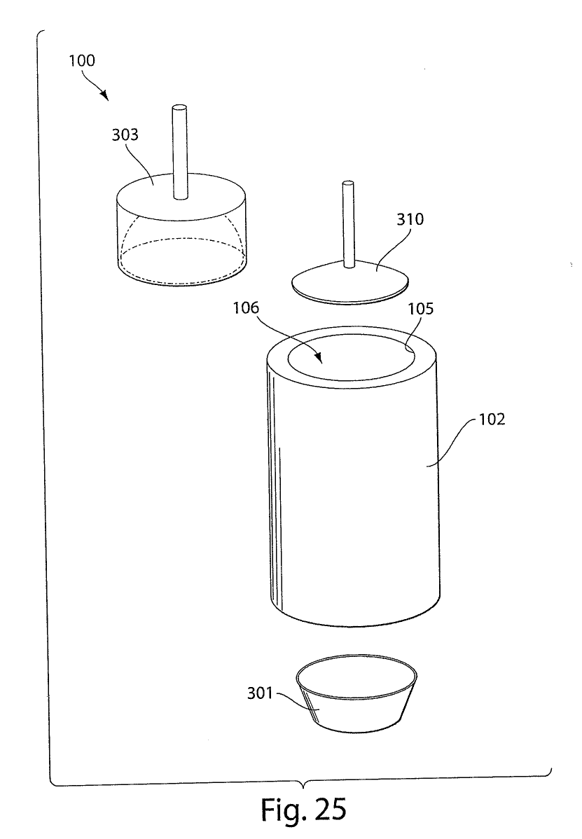

Referring to FIGS. 25-27, an additional tool that may deploy individually, or as one of the set of tools configured and arranged as the tool support structure 316 shown in FIG. 32, includes the reservoir coating tool 310. The reservoir coating tool 310 is constructed and arranged to apply liquid product mix or liquid product mix ingredients along at least a portion of the inner wall 105. Similar to the deployment of the tools 303, 304 and 308 described above, the chamber 102 may align, e.g., vertically below, with the reservoir coating tool 310, as shown in FIG. 25. The reservoir coating tool 310 is constructed and arranged to apply liquid along at least a portion of the inner wall 105 from its top surface 311. Where the reservoir coating tool 310 deploys within the food passage 106, an amount of product mix or product mix ingredients is disposed along the top surface 311 of the tool 310. When the tool 310 travels through the food passage 106, the product mix or ingredients flow from the top surface 311 of the tool 310 to contact and to attach to or coat at least a portion of the inner wall 105 to form thereon one or more layers, e.g., thin layers, of product mix or ingredients. The top surface 311 may define a cone shape with its center aligned with the center axis of the tool 310, wherein the downward slope of the cone shape allows liquid, semi-liquid, or solid product mix or ingredients to be presented adjacent the inner wall 105. In addition to the force of gravity presenting the product mix or ingredients to the inner wall 105, the tool 310 may be constructed and arranged to rotate about its central axis to help to facilitate deposit of a liquid, semi-liquid, or solid product mix or ingredients onto the inner wall 105. As shown in FIG. 25, the reservoir coating tool 310 may replace subsequently with the pushing/scraping tool 303 after application of product mix or ingredients.

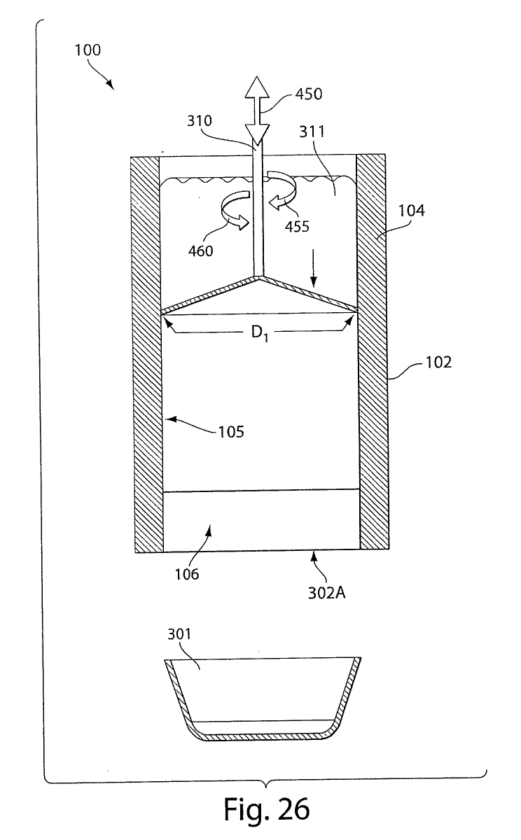

In one embodiment, the reservoir coating tool 310 may lower downward into the chamber 102 from a vertically aligned position above the chamber 102, as shown by arrow 450 in FIG. 26, to deploy the tool 310 within the food passage 106. The tool 310 moves in a downward orientation, as shown by arrow 450 in FIG. 26, toward the chamber base 302A to apply liquid product mix and/or ingredients to at least a portion of the inner wall 105 for food product formation. As the tool 310 moves in a vertically in a downward orientation, the liquid product mix or ingredients flow from the top surface 310 and contact the inner wall 105 such that liquid product mix or ingredients attach or coat at least a portion of the inner wall 105.

The tool 310 may be removed from the food passage 106 in an upward orientation, as shown by 450 in FIG. 26, to remove the tool 310 from the food passage 106 and, optionally, to return the tool 310 into the food passage 106 for a second or more passes through the food passage 106 to apply additional liquid product mix or ingredients to at least a portion of the inner wall 105.

Alternatively, or additionally, the reservoir coating tool 310 may rotate about an axis central to the tool 310 to aid in applying product mix or ingredients along at least a portion of the inner wall 105 of the chamber 102. As shown in FIG. 26, as the tool 310 travels through the food passage 106 vertically in a downward orientation, the tool 308 may rotate or pivot about its central axis in a clockwise and/or counter-clockwise direction, as shown by arrows 455 and 460, respectively, in FIG. 26, to help to apply product mix or ingredients to at least a portion of the inner wall 105. The tool 310 may be configured to travel the entire vertical length of the food passage 106 or chamber 102, or at least a portion of the length of the food passage 106 or chamber 102. The tool 310 may be configured to actuate or to travel, e.g., vertically, along the length of the food passage 106 or chamber 102 one or more times before any other tool deploys into alignment with the chamber 102. In one embodiment, the tool 310 travels through the food passage 106 a number of times such that product mix or ingredients apply repeatedly to at least a portion of the inner wall 105 to form the food product via thin film cooling or freezing.

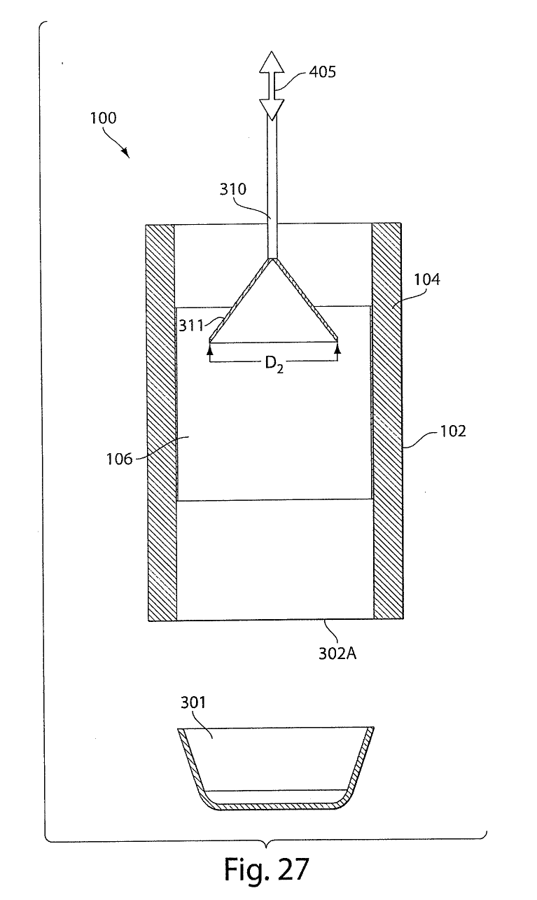

Referring to FIG. 27, in one embodiment the reservoir coating tool 310 may be constructed and arranged to permit the tool 310 to retract to a secondary position from its initial position shown in FIG. 26 such that its diameter D₁ that is defined by the outer perimeter edge or circumference of the tool 310 is reduced to define a second and smaller diameter D₂. In one configuration, the distal or bottom surface of the tool 310 may be constructed and arranged to permit the top surface 3110 to the secondary position. The secondary position of the tool 310 permits the tool 310 to raise and exit from the chamber 302 without contacting the at last partially coated inner surface 105.

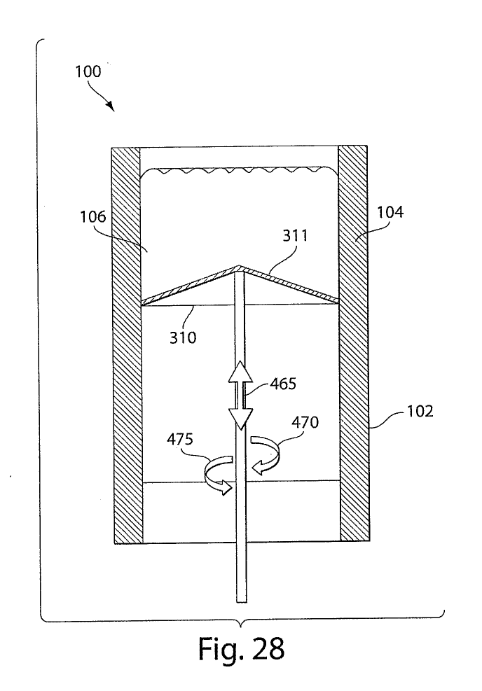

Referring to FIG. 28, in another embodiment the reservoir coating tool 310 in constructed and arranged to move in an upward orientation, as shown by arrow 465, to achieve the substantially the same results as described with reference to FIGS. 26 and 27, and/or to rotate about an axis central to the tool 310 in a clockwise and/or a counter-clockwise direction, as shown by arrows 470 and 475, respectively, in FIG. 28.

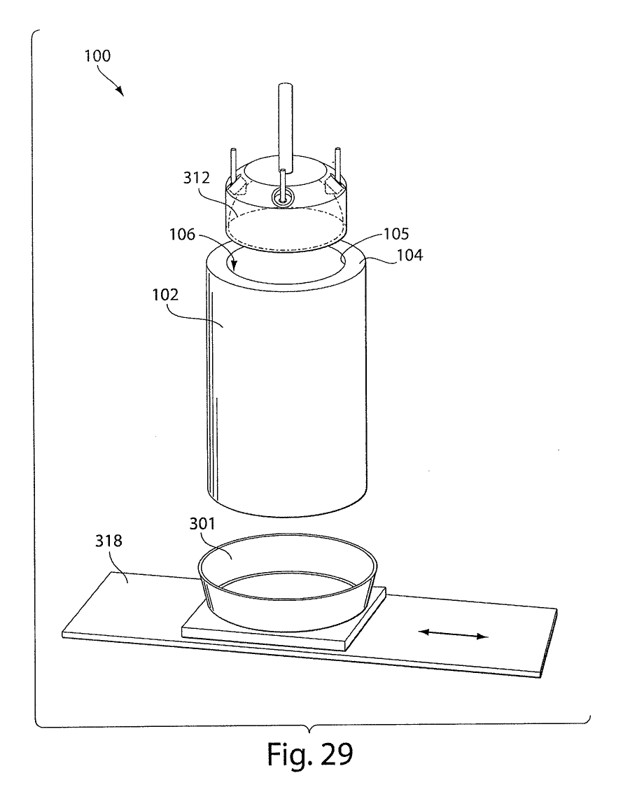

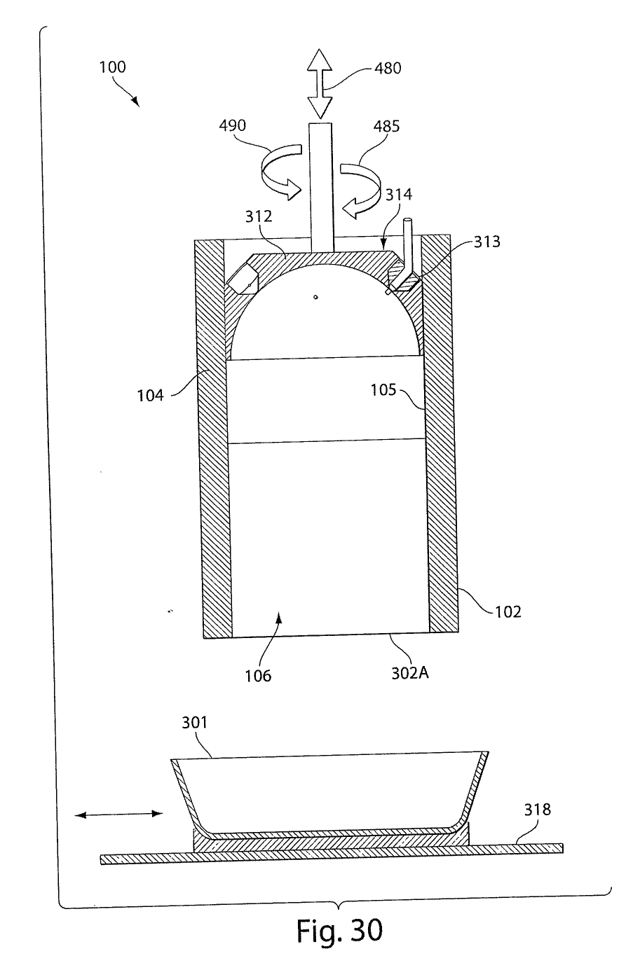

Referring to FIGS. 29-30, an additional tool assembly that may be deployed individually or as one element of the set of tools configured and arranged as the tool support structure shown in FIG. 32 includes a multi-tool head 312. The multi-tool head 312 is constructed and arranged with various components and sub-systems to perform any of a variety of tasks to form the food product within the chamber 102 including, but not limited to, dispersing or applying a product mix and/or product mix ingredients to at least a portion of the inner wall 105, to scrape food product formed along the inner wall 105 to remove food product for subsequent dispensing, to scrape additionally any food product residue from the inner wall 105 to help to clean the inner wall 105 and food passage 106, to push cooled or at least partially frozen food product removed from the inner wall 105 through the food passage 106, to shape or form the cooled or at least partially frozen food product into a desired shape or configuration, and/or to dispense the formed frozen food product from the food passage 106, e.g., and into one or more receptacles for storing or servicing the food product. In addition, the multi-tool head 312 may be constructed and arranged to receive pressurized gas, e.g., air, to help to pressurize a product mix or product mix ingredients for application along the inner wall 105 and/or to help to supply pressurized gas to pressurize the food passage 106 during processing.

As shown in FIGS. 29 and 30, the multi-tool head 312 may be constructed and arranged for several different modes of application or coating of a product mix or ingredients along at least a portion of the inner wall 105 to form a food product via thin film cooling or at least partially freezing. In one embodiment, the head 312 includes one or more nozzles 313 configured for pressurizing and/or atomizing a product mix or ingredients to spray or otherwise apply the product mix or ingredients along at least a portion of the inner wall 105. In this case, the nozzles 313 are configured and disposed to receive a supply of pressurized gas, e.g., air, to pressurize and/or atomize the product mix or ingredients. Alternatively, the nozzles 313 may be configured to receive a supply of pressurized gas, e.g., air, to help to aerate the product mix or ingredients prior to application along the inner wall 105. The one or more nozzles 313 are disposed along an angled inner surface of the head 312 such that the nozzles 313 aim or direct product mix or ingredients sprayed or otherwise projected from the nozzles 313 to the inner wall 105.

The head 312 may also be constructed and arranged to deploy within the chamber 102 to facilitate application of a product mix or ingredients along the inner wall 105. In this case, an amount of solid, semi-liquid or liquid product mix or product mix ingredients, or mixtures thereof, may be disposed along a top surface 314 of the head 312. Similar to the reservoir coating tool 310, the top surface 314 is cone-shaped or dome-shaped to permit the product mix or ingredients to flow from the top surface 314 to be presented adjacent the inner wall 105. In one embodiment, the head 312 may be deployed vertically within the food passage 105 in a downward orientation, as shown by arrow 480 in FIG. 30, to help to present the product mix or ingredients to the inner wall 105 such that the product mix or ingredients contact and attach to or coat at least a portion of the inner wall 105. In addition to the force of gravity presenting the product mix or ingredients to the inner wall 105, the tool 312 may be constructed and arranged to rotate about its central axis in a clockwise and/or counter-clockwise direction, as shown by arrows 485 and 490, respectively, in FIG. 30, to help to facilitate deposit of a liquid, semi-liquid, or solid product mix or ingredients onto the inner wall 105.

The head 312 may be removed from the food passage 106 in an upward orientation, as shown by 480 in FIG. 30, to remove the head 312 from the food passage 106 and the chamber 102, and, optionally, to return the tool 312 into the food passage 106 for a second or more passes through the food passage 106 to apply liquid product mix or ingredients to at least a portion of the inner wall 105.

The head 312 may be configured to travel the entire vertical length of the food passage 106 or chamber 102, or at least a portion of the length of the food passage 106 or chamber 102. The head 312 may be configured to actuate or to travel, e.g., vertically, along the length of the food passage 106 or chamber 102 one or more times. In one embodiment, the tool 312 travels through the food passage 106 a number of times such that product mix or ingredients apply repeatedly to at least a portion of the inner wall 105 to form the food product via thin film cooling or freezing.

In addition, the head 312 may employ the one or more nozzles 313 or may include other nozzles (not shown) that may be employed to spray or otherwise apply one or more materials along at least a portion of the inner wall 105 including, but not limited to, one or more materials that help to facilitate cooling or at least partially freezing a product mix or ingredients and/or to help to facilitate removal of the food product from the inner wall 105. Similarly, the other nozzles may be used to apply one or more cleaning materials along the inner wall 10, the food passage, and/or other areas of the chamber 102 to help to remove any residual product mix or ingredients and/or food product and to help to otherwise clean the chamber 102.

Also referring to FIGS. 29-30, the system 300 may include a linear actuator or conveyor belt mechanism 318, configured to present or align a receptacle 301 beneath the open plate 302A of the cooling chamber 302 to deploy the receptacle 301 for receiving the food product dispenses through the one or more valves or orifices (not shown) of the bottom plate 302A.

Referring to FIGS. 31 and 32, in some embodiments one or more food-zone assemblies 100 and/or one or more chambers 102, as described above with reference to FIGS. 11-30, may be configured and arranged as a multiple of assemblies 100 or chambers 102 to define a multi-chamber food-zone assembly 500. In one embodiment, the assembly 500 includes a multiple of chambers 102 configured and disposed within a multi-chamber support 502. The multi-chamber support 502 is constructed and arranged such that one or more of the chambers 102 align, e.g., vertically below, with one or more of the individual tools 303, 304, 308, 310 and 312 described above, as shown in FIG. 31. Alternatively, as shown in FIG. 32, the multi-chamber support 502 is constructed and arranged such that the multiple chambers 102 align, e.g., vertically below, with the tool support structure 316. The embodiments shown in FIGS. 31 and 32 are constructed and arranged to permit the multi-chamber support 502 to rotate, e.g., horizontally, or to translate to help to align the support 502 with one of the tools 303, 304, 308, 310 and/or 312, or with the tool support structure 316, such that any of the tools may be aligned with and deployed within the food passage 106 of one of the chambers 102.

As shown in FIG. 31, the multi-chamber support 502 is constructed and arranged to rotate horizontally along an axis central to the support 502 in a clockwise and/or a counterclockwise direction, as shown by arrows 510 and 512, respectively, in order to align each of the cooling chambers 102 vertically below any of the tools 303, 304, 308, 310 and/or 312. In one case, each tool disposed vertically above one chamber 102 may include a tool different from a tool disposed vertically above another adjacent chamber 102 within the support 502. In another case, the tools disposed vertically above the chambers 102 are identical.

In the case of different tools deployed vertically above the support 502, each tool may deploy downward simultaneously or serially into one of the chambers 102, wherein each tool may be performing a different task in the food production process. By way of example, and without limitation to the invention, the spin coating tool 308 (not shown in FIG. 32) may deploy into one chamber 102, while the pushing/scraping tool 303 may deploy simultaneously into another chamber 102. Subsequent to each tool 303 and 308 performing its respective task. The multi-chamber support 502 may rotate horizontally or may translate to reposition each of the chambers 102 such that each chamber 102 aligns vertically below an adjacent or different tool. As shown in FIG. 32, the four chambers 102 may each be engaged in a different task at any give time. For example, one chamber 102 may receive the applicator 304 to apply product mix or product mix ingredients to at least a portion of the inner wall 105 for cooling or at least partially freezing; a second chamber 102 may receive the pushing/scraping tool 303 to remove food product from along the inner wall 105 of the chamber 102; a third chamber 102 may receive the spin coating tool 308 for applying one or more materials, e.g., air or cleaning fluid, to help to clean and remove residual food product from the chamber 102; and a fourth chamber 102 may receive a second spin coating tool 308 or, for instance, the reservoir coating tool 310 for applying one or more materials along at least a portion of the wall 105 that help freeze a product mix along the wall 105 and/or that help to remove a food product from the wall 105. In this manner, each chamber 102 is performing substantially simultaneously a different task of a production cycle. Alternatively, or additionally, the plurality of tools or the tool support structure 316 may rotate horizontally or may translate to reposition each tool such that each tool aligns vertically above one of the chambers 102. The tools may also operate synchronously or independently. The positioning of the chambers 102 relative to separate tools or the tool support structure 316 may occur synchronously with or independently of the positioning of the tools or the tool support structure 316.

By way of another example, and without limitation to the invention, one chamber 102 may receive the applicator 304 and another chamber 102 may receive the pushing/scraping tool 303. When the tool-specific tasks are completed, the support 502 may rotate horizontally or may translate to reposition the one chamber 102 and the other chamber 102 in alignment with a different tool to perform the next task in the production cycle. (Alternatively, the tools or the tool support structure 316 may rotate horizontally or may translate to reposition the tools in alignment with a different chamber 102 to perform the next task.) The one chamber 102 that received the applicator 304 may receive subsequently the scraping/pushing tool 303, while the another chamber 102 that received the scraping/pushing tool 303 may receive subsequently the spin coating tool 308 to clean the chamber 102.

As shown in FIGS. 31 and 32, the rotation or translation of the multi-chamber support 502 may synchronize with the progress of the food production process in one or more chambers 102 and/or with the completion of the one or more tasks within one or more chambers 102 to form the food product. In addition, the support 502 rotates or translates relative to any of the tools 303, 304, 308, 310 and/or 312 that remain stationary until deployment into a chamber 102. Alternatively, the support 502 rotates or translates relative to the tool support structure 316 that remains stationary. As shown in FIG. 32, the tool support structure 316 may include any of the tools 303, 304, 308, 310 and/or 312 described above, wherein the structure 316 may include the same or different tools along each of its branches 316A. Alternatively, or additionally, any of the individual tools 303, 304, 308, 310 and/or 312 or the tool support structure 316 may rotate or translate relative to the support 502 or an individual chamber 102. Rotations of the support 502 and the tools 303, 304, 308, 310 and/or 312 and the tool support structure 316 may be configured to be wholly or partially synchronous with one another to help to achieve continuous operation of the chambers 102 and/or to help to dedicate or to specialize one or more chambers 102 for a specific food product.

With further reference to FIG. 32, in some embodiments, a multiple of forming receptacles 301, described above with reference to FIG. 23, are configured and disposed within a multi-receptacle support 600. The multi-receptacle support 600 is constructed and arranged such that one or more of the receptacles 301 align, e.g., vertically below, with one or more of the chambers 102, e.g., disposed within the multi-chamber support 502, as shown in FIG. 32. The support 600 is constructed and arranged, e.g., with one or more ports 600A, to receive one or more receptacles 301. The support 600 is also constructed and arranged to permit the multi-receptacle support 600 to rotate, e.g., horizontally, or to translate to help to align the support 600 and the one or more receptacles with one or more chambers 102 and, more particularly, with one or more bottom plates 302A of the chambers 102. In the embodiment shown in FIG. 32, the support 600 rotates horizontally in a clockwise and/or counter-clockwise direction, as shown by arrows 610 and 612, respectively, in FIG. 32 to deploy each of the receptacles 301 below one of the chambers 102 such that one or more receptacles 301 may receive a food product the chamber 102 dispenses through the bottom plate 302A. The rotation of the support 600 may synchronize wholly or partially with the rotation of the chamber support 502 and/or the rotation of any of the tools 303, 304, 308, 310 and/or 312 and/or the rotation of the tool support structure 316.

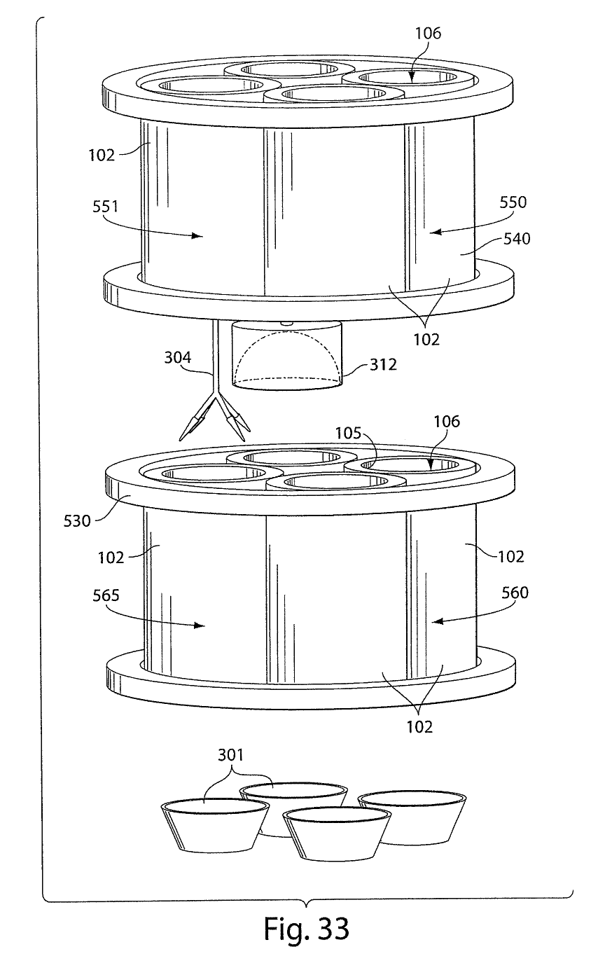

Referring to FIG. 33, and with further reference to FIGS. 31 and 32, in one embodiment a first multi-chamber support 530 is provided similar to the multi-chamber support 502 described above with further reference to FIGS. 31 and 32. While the embodiment of the support 502 shown in FIGS. 31 and 32 may include each of the one or more chambers 102 constructed and arranged as a mixing chamber and a cooling chamber to perform mixing and cooling tasks, the first support 530 of the embodiment shown in FIG. 33 may include each of the one or more chambers 102 constructed and arranged as a cooling chamber. A second multi-chamber support 540 may include each of the one or more chambers 102 constructed and arranged as a mixing chamber. Each mixing chamber 102 of the second support 540 may align with one of the cooling chambers 102 of the first support 530 such that a product of the mixing chamber 102 may be dispensed therefrom into the cooling chamber 102. Any one of the tools 304, 308, 310 and/or 312 described above that are constructed and arranged to apply a product mix or ingredients along at least a portion of the inner wall 105 may be employed to receive and to apply the product of the mixing chamber 102 of support 540 to the inner wall 105 of the cooling chamber 102 of support 530.

In this manner, one or more of the mixing chambers 102 may be dedicated or specialized for preparation of a particular product mix or one or more ingredients that comprise a product mix. For instance, one or more of the mixing chambers 102 of the second support 540 may be dedicated to blending one or more flavorings with a product base mix, e.g., an ice cream product base mix. In another instance, the one or more other mixing chambers 102 of the second support 540 of the second support 540 may be dedicated or specialized to aerating or agitating a product base mix previously blended with one or more flavorings. The dedicated or specialized mixing chambers 102 help to at least minimize cross-contamination of product base mixes and/or one or more flavorings, and/or, optionally, one or more add-ins between production cycles of individual food product servings or batches.

As shown in FIG. 33, the spray coating tool 304 may be employed to receive a product mix or product mix ingredients from one of the mixing chambers 102, while the multi-tool head 312 may be employed to receive a product mix or product mix ingredients from another of the mixing chambers 102. The tools 304 and 312 thereafter apply the product mix or product mix ingredients along at least a portion of the inner wall 105 of their respective cooling chambers 102 to form a food product from thin film cooling or at least partially freezing. The tools 304, 308, 310 and/or 312 may be dedicated or specialized to a particular mixing chamber 102 depending on the products or the types of product mixes and/or product mix ingredients that the particular mixing chamber 102 provides. Any of the tools 304, 308, 310 ad/or 312 may be selectively employed within or dedicated to a particular chamber 102 to apply a certain type of product mix or product mix ingredients to the inner wall 105, which thereby helps to optimize the performance of the tool and helps to optimize the application of the product mix or the product mix ingredients to the inner walls 105 as one or more, e.g., thin, layers. In this manner, the supported chambers 102 and the tools 304, 308, 310 and/or 312, and/or the tool support structure 316, may help to produce efficiently individual food product servings or batches of food product and may help to produce the desired consistencies, textures and/or other properties of the food products with serving-to-serving or batch-to-batch consistency.

As shown in FIG. 33, the first support 530 may rotate, e.g., horizontally, relative to the second support 540 in a clockwise or a counter-clockwise direction, as shown by arrows 560 and 565, respectively. Alternatively, or additionally, the second support 540 may be rotated, e.g., horizontally, relative to the first support 530 in a clockwise or a counter-clockwise direction, as shown by arrows 550 and 555, respectively, in FIG. 33.

Rotations of the multi-chamber supports 530 and 540 and/or rotations of the individual tools 303, 304, 308, 310 and/or 312 that may be deployed within the chambers 102, and/or the rotations of the tool support structure 316, may be synchronized to allow for a continuous operation and/or specialization of one or more of the mixing or cooling chambers 102, one or more of the tools 303, 304, 308, 310 and/or 312, and/or one or more forming receptacles 301. Rotations may also be configured and arranged to be asynchronous or partially synchronous and asynchronous for one or more mixing chambers or cooling chambers 102 and one or more tools 303, 304, 308, 310 and/or 312. Similar configurations and arrangements may be adopted for robotics and/or linearly actuated cooling chambers, tools, mixing chambers, or forming receptacles.

With further reference to FIG. 32, the tool support structure 316, as mentioned, may include one or more of any of the tools 303, 304, 308, 310 and/or 312 integrated with each of the structure branches 316A such that the structure 316 is configured and is disposed as a rotating turret. Any of the tools 303, 304, 308, 310 and/or 312 may be removably connected to a branch 316A. In addition, additional tools or devices including, but not limited to, brushes and sprayers may be removably connected to a branch 316A to address specific tasks or functions, e.g., cleaning and coating the inner wall 105, the food passage 106 and the chamber 102.

Referring to FIG. 34, in some embodiments either or both of the multi-chamber supports 530 and 540 may align with one or more of the tool support structures 316.

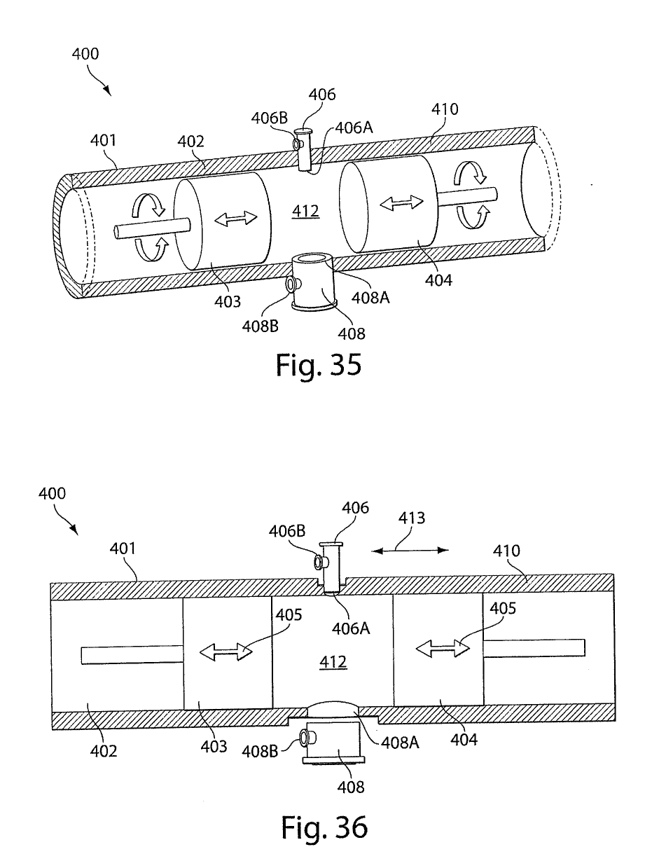

Referring to FIGS. 35-37, in another aspect the invention provides a mixing chamber system 400 including an elongated housing 401 that defines within its interior a mixing chamber 402 and includes an exterior surface 410 of the mixing chamber 402. The mixing chamber 401 may be constructed and arranged to blend and mix and/or to aerate, e.g., under pressure, any of a product base mix, one or more flavorings and/or one or more add-ins, as described above. The system 400 includes a first pushing apparatus 403 and a second pushing apparatus 404 disposed within the housing 401 and an internal mixing space 412 defined therebetween. The system 400 also includes an inlet passage 406 and an outlet passage 408.

In one embodiment of the system 400 the mixing chamber 402 may be constructed of one or more materials suitable to provide the housing 401 with a thickness and a strength such that the chamber 402 maintains its shape and configuration while high internal pressures are applied within the interior of the chamber 402. In one embodiment, the chamber exterior surface 410 may incorporate suitable insulation material. In another embodiment the housing 401 may include a refrigerated wall extending partially or wholly along the mixing chamber 402.

As shown in FIGS. 35 and 36, in one embodiment, the mixing chamber 402 may be disposed horizontally and the first and second pushing apparatuses 403 and 404 may be constructed and arranged as horizontally opposed pistons contained within the interior volume of the mixing chamber 402. The interior configuration of the mixing chamber 402 defines the internal mixing space 412 as a cylindrical or tubular shape and defines the chamber 402 with a generally circular cross-section. The first and second pushing apparatuses 402 and 404 may be positioned on opposing sides of a center of the mixing chamber 401 to define the internal mixing space 412. The first and second pushing apparatuses 402 and 404 are further constructed and arranged to actuate and to move, individually and/or in synchrony with one another, along a horizontal plane within the chamber 401.

The inlet passage 406 is constructed and arranged to couple with a port 406A defined along the housing 401 and with a valve or other flow regulator 406B to help to control the throughput of liquids, semi-solid, and solids, and gas, e.g., pressurized or non-pressurized air, through the inlet passage 406 into the mixing chamber 402. The liquids, semi-solids and solids may include any of a variety of forms of a product mix comprising a product base mix blended with one or more flavorings and, optionally, with one or more add-ins, or may include the individual ingredients of the product mix. Product mix, the noted product mix ingredients, and/or gas, e.g., pressurized air or non-pressurized air, may dispense through the inlet passage 406 and the port 406A to occupy the internal mixing space 412 defined between the first and second pushing apparatuses 402, 404. The valve or regulator 406B is configured and disposed to regulate the flow or dispense of the product mix or ingredients, as well as flow and volume of pressurized gas entering into the mixing space 412. The valve or regulator 406B is also configured and disposed to close off the mixing chamber 402 to help to prevent backflow or escape of any of the chamber 402 contents. During mixing and blending, additional liquids, semi-solid, solids, or gas, e.g., air may be added through the inlet passage 406 and port 406A with the valve or regulator 406B controlling such additions.

The first and second pushing apparatuses 402 and 404 are actuated to move horizontally, e.g., back and forth or left and right, as shown by arrows 405 in FIG. 36, to mix and to agitate the contents of the mixing chamber 401 for a configurable amount of time in order to achieve blending and mixing of the contents and/or aerating of the contents. To help to increase agitation of the contents, the relative positions of the first and second pushing apparatuses 403 and 404 and the mixing chamber 402 may be changed.

As shown in FIG. 36, in one embodiment, the first and second pushing apparatuses 403 and 404 are constructed and arranged to move left and right horizontally and the chamber 402 remains stationary, or the chamber 402 is constructed and arranged to move left and right horizontally, as shown by arrow 413 in FIG. 36, and the first and second apparatuses 403 and 404 remain stationary. In another embodiment, the chamber 402 and the apparatuses 403 and 404 are constructed and arranged to move left and right horizontally at substantially the same time or at different times. In another embodiment, the pushing apparatuses 403 and 404 maintain a position relative to one another. Alternatively, or additionally, the positions of the pushing apparatuses 403 and 404 relative to each other may change over time to help to vary pressure within the mixing chamber 402 such that the mixing and blending process as well as aeration of the contents may be controlled.

The internal walls of the mixing chamber 402 that define the mixing space 412 may include one or more protrusions, notches and/or orifices (not shown) to aid in agitation of the contents of the chamber 40.

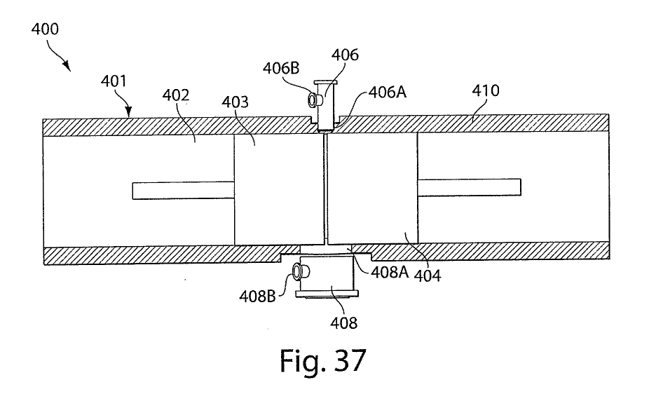

As shown in FIG. 37, when the one or more processes of blending or mixing and/or aerating the chamber 402 contents is complete, e.g., whereby an aerated food product base mix or aerated product mix ingredients are formed, the first and second pushing apparatuses 403 and 404 contract and/or move horizontally toward each other to help to push the aerated contents within the mixing space 412 and through the outlet passage 408 for dispensing. The outlet passage 408 is constructed and arranged to couple with an outlet port 409A defined along the housing 401 and with a valve or other flow regulator 409B to help to control the throughput of the food product from the mixing space 412 through the outlet passage 408 such that the food product is controllably dispensed or transported to a second cooling chamber. Alternatively, or additionally, the first and second pushing apparatuses 403 and 404 may move to another section of the mixing chamber 401 to dispense the product.

The inlet passage 406 and port 406A and the outlet passage 408 and port 408A may be operatively connected and defined in any location along the mixing chamber 402. In some embodiments, the mixing chamber 401 may not include the inlet and outlet passages 406 and 408 if one or both of the pushing apparatuses 402 and 404 from one or both ends of the mixing chamber 402 extracts the contents of the mixing chamber 402 from the chamber 402.

In some embodiments, the mixing chamber 402 may be constructed and arranged to cool or at least partially freeze the product mix or product mix ingredients. In such embodiments, the chamber 402 walls are constructed and arranged similar to the refrigerated wall 104 described above with reference to FIGS. 11-14. Once the chamber 402 has produced the desired or required contents, as described above, the chamber 402 walls may cool to any of desired temperatures in a range sufficient to cool or at least partially freeze the aerated contents. In this case, at least a portion of the contents contacting the interior walls of the chamber 402 will cool or at least partially freeze. The first and second pushing apparatuses 403 and 404 may be further constructed and arranged to remove or scrape cooled or at least partially frozen contents from the walls of the chamber 402 and to mix further the contents to achieve desired food product consistencies, textures and/or other properties. Cooled or at least partially frozen contents dispense from the chamber 401 as described above.

In describing embodiments of the invention, specific terminology is used for the sake of clarity. For purposes of description, each specific term is intended to at least include all technical and functional equivalents that operate in a similar manner to accomplish a similar purpose. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Further, where parameters for various properties are specified herein for embodiments of the invention, those parameters can be adjusted up or down by 1/20^{th}, 1/10^{th}, ⅕^{th}, ⅓^{rd}, ½, etc., or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention; further still, other aspects, functions and advantages are also within the scope of the invention. The contents of all references, including patents and patent applications, cited throughout this application are hereby incorporated by reference in their entireties. The appropriate components and methods of those references may be selected for the invention and embodiments thereof. Still further, the components and methods identified in the Background section are integral to this disclosure and can be used in conjunction with or substituted for components and methods described elsewhere in the disclosure within the scope of the invention.

What is claimed is:

1. A food-zone system for preparing a chilled or at least partially frozen food product comprising:
at least one chamber assembly including a chamber with an interior configuration that defines a food passage extending therethrough with a cylindrical or tubular shape;
the chamber being sealed along at least one end;
an exterior wall of the chamber being configured as a refrigerated wall including an interior adapted to circulate coolant; and
a scraping tool operatively coupled with the chamber and extending into the food passage, the scraping tool being configured such that an outer perimeter of the scraping tool contacts at least a portion of the interior configuration of the chamber,
wherein, as the scraping tool moves through the food passage, the scraping tool removes or scrapes a food product mix disposed along at least a portion of the interior configuration of the chamber when the food product is chilled or at least partially frozen.

2. The food-zone system of claim 1, wherein the chamber defines at least one port along the chamber and includes a regulator configured to seal the chamber and to provide fluid communication between an area external to the chamber and the interior of the chamber.

3. A food-zone system for preparing a chilled or at least partially frozen food product comprising:
a plurality of chamber assemblies, the chamber assemblies being arranged about a central axis, each chamber assembly including:
an interior configuration that defines a food passage extending therethrough with a cylindrical or tubular shape;
an exterior wall of the chamber being configured as a refrigerated wall including an interior adapted to circulate coolant; and
a tool support structure operatively coupled with the plurality of chambers and spaced from each chamber, the tool support structure configured with one or more process tools and adapted to rotate to position the process tools relative to the chambers,
wherein each tool being disposed in alignment with one of the chambers and being configured to deploy within the food passage of the chamber.
